(19) United States
(12) Patent Application Publication
(10) Pub. No.: US 2007/0050243 A1
(43) Pub. Date: Mar. 1, 2007

(54) Multi-unit system and methods for game augmented interactive marketing

(75) Inventor: Michael S. Kralik, Sandy, UT (US)

Correspondence Address: BLACK LOWE & GRAHAM, PLLC, 701 FIFTH AVENUE, SUITE 4800, SEATTLE, WA, 98104, US

(73) Assignee: Way Out World, LLC, Shoreline, WA (US)

(21) Appl. No.: 11/209,572

(22) Filed: Aug. 23, 2005

(51) Int. Cl. G07G 1/14

(52) U.S. Cl. 705/14

(57) ABSTRACT

The present invention provides multi-unit systems and methods for game augmented interactive marketing or information presentation. A system includes a first advertising unit includes a first processor and a second unit including a second processor both adapted to run an entertainment sequence. The user may restate information provided by the first unit or the second unit. A method for interactive advertising includes soliciting a play move with a first device. The user may respond to a second device. The response may include a product slogan. User information may be communicated between the first unit and the second unit. A method for interactive advertising includes soliciting a play move with a first device, receiving a response to a second device, and storing information on a parent processing unit. Aspects of the invention may also include delivering a token or an information key and recognizing the token or key.

### FIELD OF THE INVENTION

This invention relates generally to interactive systems and, more specifically, to systems for interactive marketing.

### BACKGROUND OF THE INVENTION

So-called interactive marketing or information providing devices and systems typically utilize a computer network such as the Internet, or simple coupon dispensing machines. These devices' and systems' self-described “interactions” with a customer or user usually involve a simple or singular solicitation and response, but do not engage or entertain the customer or user on a continuous and programmed basis. Similarly, preference card systems, such as grocery store “loyalty cards,” may permit limited tallying of a customer's purchases. They do not otherwise assist in evaluating the customer's broader preferences, provide interaction with or information about targeted products or products considered or viewed by the customer, or provide for the customer's response or disposition with respect to various marketing programs including specific product advertising. While print media advertising, signs, and billboard advertising provide limited product exposure to customers, and users of facilities, they are not related to the experience of a user at the advertised site or at the actual point of product selection or purchase when handling the advertised product. Accordingly, there is an unmet need for interactive systems that can engage a user or customer at a higher level, for these purposes.

### SUMMARY OF THE INVENTION

The present invention is directed towards methods, apparatus, and systems that, through multiple sensing devices, track and interact with customers while providing game augmented advertising incorporating audio, visual, olfactory and/or kinesthetic stimuli for the purpose of (1) product marketing, (2) advertising impression verification, and (3) providing customer information, education and/or entertainment. Enhanced point of sale, or point of product or service interactions are provided, and customer or user responses may be tallied or compiled, resulting in refined marketing data, more specifically in reflecting the customer's or user's experience than that provided, by way of example, by a marketing focus group.

The present invention is directed toward multi-unit systems and methods for game augmented interactive marketing, advertising impression verification, consumer education, education, or information presentation. In one embodiment, a first advertising unit includes a first processor adapted to run an entertainment sequence. The entertainment sequence includes a plurality of steps that may be taken by the user. The first unit includes a sensor adapted to sense information about the user related to the entertainment sequence, and a first input device adapted to receive information from the user. The first unit includes a first output device adapted to transmit media to the user and an input device adapted to receive information from the user related to the entertainment sequence. The system also includes a second unit including a second processor adapted to run the entertainment sequence. The second advertising unit also includes an audio output device, a second sensor, and an input device adapted to receive information, and an audio output device related to the game entertainment sequence. In other aspects of the invention, the entertainment sequence includes a game. In further embodiments of the invention, the information provided by the user includes information provided by the first advertising unit or the second advertising unit.

In another aspect of the invention, a method for interactive advertising or information presentation includes detecting the user in proximity to a first interactive device, and soliciting a play move from the user with the first device, the play move includes at least one step from a game sequence. The user responds to a second interactive advertising device with the play move, and the play moves of the user are tallied. In another embodiment, the play move includes recognition or restatement of a product logo, product slogan, or product jingle, or product information that provides advertising impression verification. In another aspect of the invention, the user is informed that a game sequence is available for game playing. In further aspects of the invention, the user is identified. In yet another embodiment of the invention, the identity of the user is communicated between the first advertising unit and the second advertising unit. In a further embodiment, a first advertising unit, second advertising unit, and a parent unit are adapted to run an entertainment sequence. The parent unit may include a data storage device arranged to store information concerning the user, and/or tally the steps or moves taken by the user. In accordance with other aspects of the invention, a method for interactive advertising includes detecting a user in proximity to a first interactive advertising device, soliciting a play move from the user with the first device, responding by the user to a second interactive advertising device, and storing information concerning the user and information concerning the play moves on a parent processing unit. Aspects of the invention may also include delivering a token or a information key to the user and recognizing the token or key delivered to the user.

### BRIEF DESCRIPTION OF THE DRAWINGS

The preferred and alternative embodiments of the present invention are described in detail below with reference to the following drawings:

FIG. 1 is a component drawing of the exemplary interactive marketing device in accordance with an embodiment of the present invention;

FIG. 2 is a component drawing of an exemplary game unit in accordance with an embodiment of the present invention;

FIG. 3 is a front view of an exemplary game unit in accordance with an embodiment of the present invention;

FIG. 4 is a top view of an exemplary game unit with customers in accordance with an embodiment of the present invention;

FIG. 5 is a side view of an exemplary game unit in accordance with an embodiment of the present invention;

FIG. 6 is a pictoral view of an exemplary game unit with shelf sensors in accordance with an embodiment of the present invention;

FIG. 7 is a symbolic drawing of a 2-unit game system in accordance with an embodiment of the present invention;

FIG. 8 is a component drawing or schematic drawing of a multi-unit advertising game system including a central processor, in accordance with an embodiment of the present invention;

FIG. 9 is a component drawing of a central processor in accordance with an embodiment of the present invention;

FIG. 10 is a plan view of an exemplary store facility with a marketing system in accordance with an embodiment of the present invention;

FIG. 11 is a component drawing of a multi-modal game system in accordance with an embodiment of the present invention;

FIG. 12 is a pictoral diagram of a multi-modal game system in accordance with an embodiment of the present invention;

FIG. 13 is a flowchart of an exemplary interactive marketing game in accordance with an embodiment of the present invention;

FIG. 14 is a flowchart of an exemplary preference game in accordance with an embodiment of the present invention;

FIGS. 15A, 15B, 15C, and 15D are flowcharts of an interactive marketing game for two advertising units in accordance with an embodiment of the present invention;

FIG. 16 is a flowchart of a projection marketing game in accordance with an embodiment of the present invention;

FIG. 17 is a flowchart of an audio movement interactive marketing game in accordance with an embodiment of the present invention;

FIG. 18 is a flowchart of a ‘lead-to’ interactive marketing game in accordance with an embodiment of the present invention;

FIG. 19 is a flowchart of an exemplary double product interactive marketing game in accordance with an embodiment of the present invention;

FIG. 20 is a flowchart of an exemplary product jingle game in accordance with an embodiment of the present invention;

FIG. 21 is a flowchart of an exemplary haunted house game in accordance with an embodiment of the present invention;

FIG. 22 is a flowchart of exemplary sensor inputs and choices in accordance with an embodiment of the present invention;

FIG. 23 is a flowchart of a multi-modal interactive marketing game in accordance with an embodiment of the present invention; and

FIG. 24 is a flowchart of a left brain/right brain game sequence in accordance with an embodiment of the present invention.

### DETAILED DESCRIPTION OF THE PREFERRED EMBODIMENT

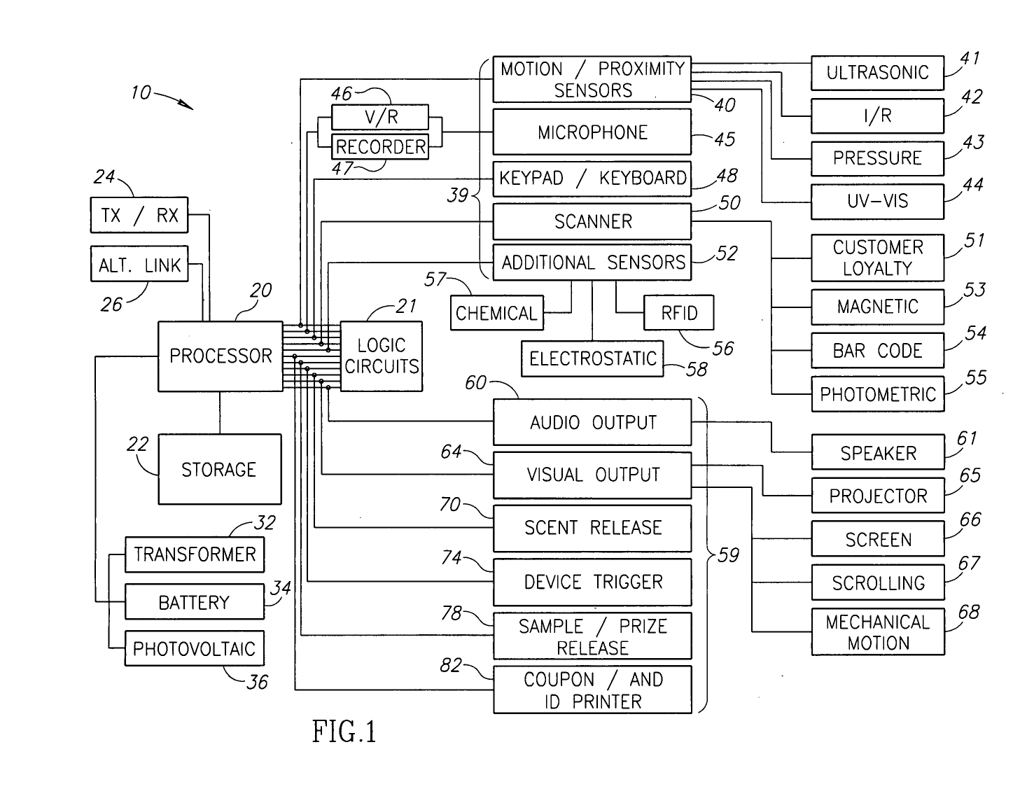

The present invention relates to multi-unit systems and methods for game augmented interactive marketing, advertising impression verification, and information exchange. Many specific details or certain embodiments of the invention are set forth in the following description and in FIGS. 1-24 to provide a thorough understanding of such embodiments. One skilled in the art, however, will understand that the present invention may have additional embodiments, or that the present invention may be practiced without several details described in the following description.

FIG. 1 is a component diagram of an exemplary game augmented interactive marketing unit 10 in accordance with an embodiment of the present invention. A processor 20 is in data communication with a plurality of input devices 39 and output devices 59. In some embodiments, the processor 20 is augmented by or replaced with hardwired logic circuits 21, in data communication with the processor 20 and/or the input devices 39 and output devices 59. The logic circuits 21 respond with portions of or a complete fixed game sequence, as compared to more readily re-programmable game sequence(s) operated by the processor 20. The processor 20 and related devices may be powered by a battery 34 recharged by a photovoltaic system 36, linked, by way of example, to the processor 20 through a transformer 32 or other power supply controller. The processor 20 may be in data communication with other marketing units (not shown) or a parent processor (not shown) through a transmitter and receiver 24 or an alternate link 26. The alternate link 26, by way of example, not limitation, may include direct wiring, fiber-optic cable, or links through a computer network. The processor 20 is in data communication with memory or storage unit 22 adapted to store information related to an entertainment sequence, such as, by way of example, but not limitation, a multi-step game to be played by a user or customer. The storage unit 22 may also be adapted to store information concerning the user, including the steps taken by the user in participating in the entertainment sequence run by the processor 20.

The processor 20 is adapted to run a sequence of steps related to an entertainment sequence. The entertainment sequence suitably may include a game for the amusement or diversion of a customer or user. A game may be an activity engaged in by the user for amusement or entertainment, involving steps by the user. The predetermined steps in a game are a game sequence, a step taken by a user is a game move, and the actual series of steps taken by a particular user is that user's play pattern. An entertainment sequence may also provide direct entertainment of the user, with or without predetermined steps by the user, or provide information to the user without involving a marketing program. An example entertainment sequence may include, for example, participation by the user in a haunted house scenario. A teaching entertainment sequence may provide educational information to the user in a sequence of moves.

Inputs from the input devices 39 to the processor 20 providing information from or concerning a user include, by way of example, but not limitation, inputs from motion proximity sensors 40, a microphone 45, a keypad or keyboard 48, a scanning device 50, and further sensors 52 utilized for the game sequence. The motion proximity sensors 40 may include an ultrasonic sensor 41, infrared sensors 42, pressure or weight sensors 43, and/or sensors in the ultraviolet or visual light ranges 44.

The microphone 45 is suitably in data communication with the processor 20 with a voice recognition system 46 converting voice input into identifiable words or responses relating to the game sequence for use by the processor 20. The microphone 45 may also be connected to the processor 20 with a recording device 47 for recording portions of the user's speech or verbal output for analysis and/or replay as part of a game sequence.

The keypad or keyboard 48 may include a QWERTY keyboard, or a plurality of push buttons, arranged to permit inputs related to the game sequence run by the unit 10.

The scanning device 50 suitably may include a card scanner for customer loyalty cards 51, a magnetic stripe reader 53, a barcode scanner 54, and/or a photometric device 55, such as a colorimeter. Additional sensors 52 that may be in data communication with the processor 20 may include a radio frequency identification (RFID) transceiver 56 arranged to communicate with RFID chips or units held in or attached to products, or held by a customer or user; a chemical or odor sensor 57 sniffing air near the unit 10, or an electrostatic sensor 58, such as a touch pad.

Output devices 59 in data communication with the processor 20, by way of example, not limitation, may include an audio output device 60, a visual output device 64, a scent release device 70, a remote device trigger 74, a sample or prize release device 78, and a coupon/award printer 82. By way of example, but not limitation, the audio output device 60 may include a speaker 61.

The video output devices 64 may include a projector 65 adapted to project images or indicators for the user. Other visual output devices 64 may include a screen 66 displaying information for the user. A scrolling letter device 67 may display words for a user. A mechanical motion device 68 may provide visual output via the motion of an object. That motion, by way of example, may include animatronic motions of figurines.

A scent release device 70 suitably may release odors in accordance with steps in the game sequence.

Device triggers 74 may switch or control devices external to the unit 10. Such devices suitably may include display lighting, pointers, or remote mechanical motion devices.

A sample or prize release 78 suitably may open or otherwise dispense a sample or a prize in response to a move in the game sequence, as controlled by the processor 20.

A coupon or award printer 82, by way of example but not limitation, may print a coupon or award certificate for the customer for redemption at another location.

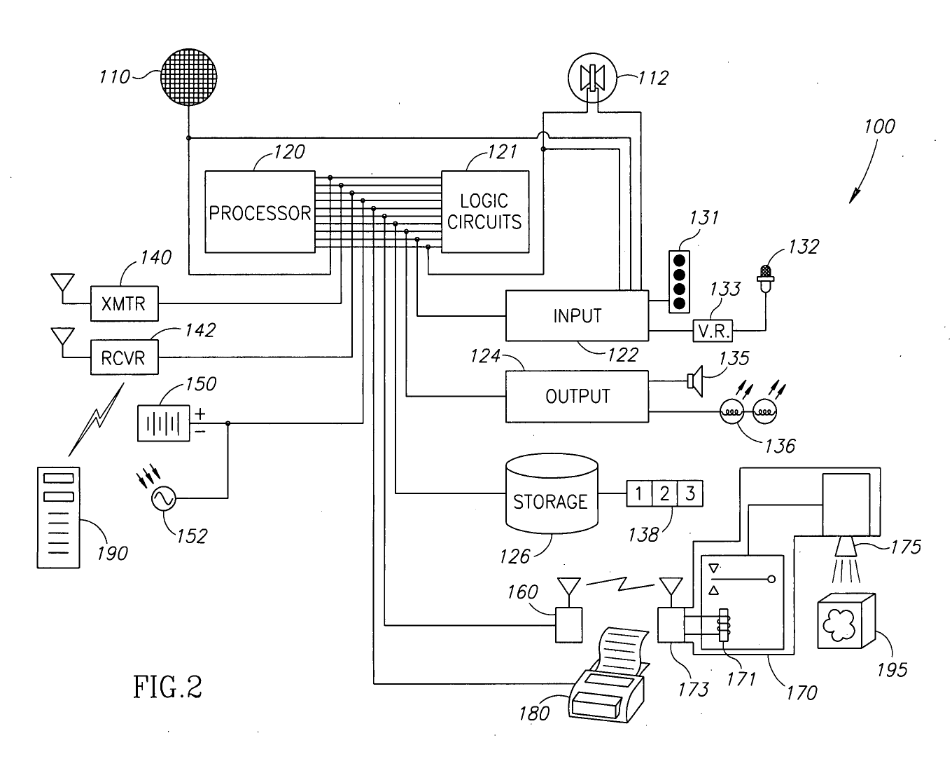

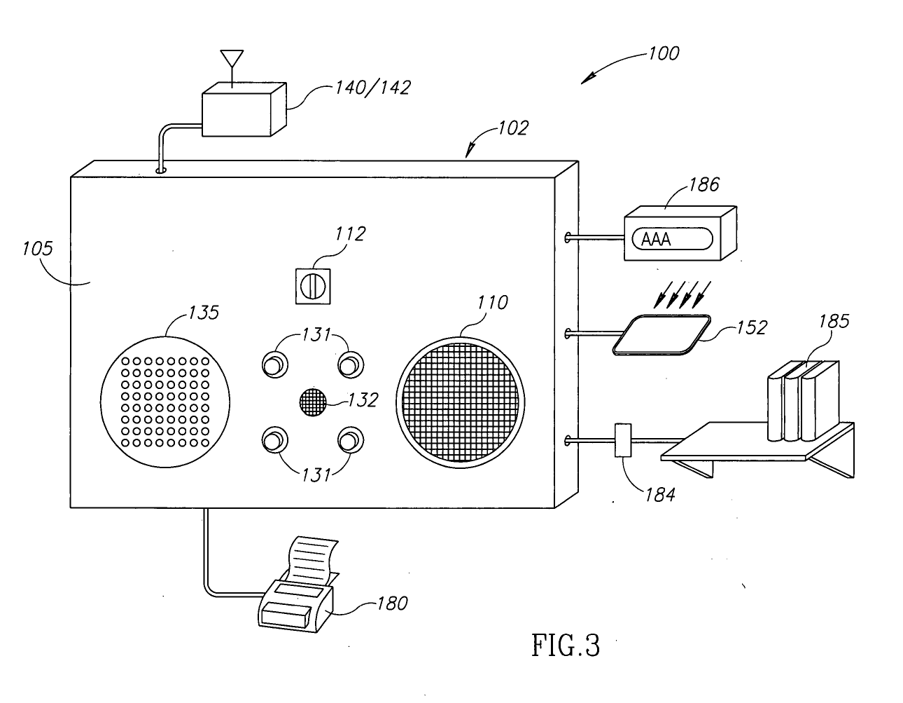

FIG. 2 is a component drawing of an exemplary modular game unit 100 in accordance with an embodiment of the present invention. A processor 120 runs a series of steps in support of an entertainment sequence. In some embodiments, the processor 120 is augmented by or replaced with hardwired logic circuits 121. By way of example, but not limitation, the processor 120 may be a MPC 5200 manufactured by Freescale Semiconductor, Inc. Logic circuits 121 suitably may include assemblies of conventional integrated circuits configured to run a logic sequence. The unit 100 includes an ultrasonic sensor 110 arranged to sense the proximity and ultrasonic characteristics of a user or customer near the unit 100. By way of example, but not limitation, the ultrasonic sensor 110 may include a Mini-S ultrasonic detector from Senscomp, Inc., with a related controller from the same manufacturer. As described further with reference to FIG. 3, in an exemplary embodiment, the ultrasonic detector 110 is directed toward the front of the unit 100. The ultrasonic detector 110 is in data communication with the processor 120 and input circuits 122 of the unit 100 for use in determining the users or customer's moves in connection with the entertainment sequence. The input circuits 122 for the ultrasonic detector 110 suitably may include a TR156 motion detector IC from KUBE, Electronics Limited.

The unit 100 also includes an infrared detector 112. By way of example, but not limitation, an exemplary infrared detector 112 includes two physically separated sensing elements facing in opposite directions, such as a KUBE 6192-3 Pyroelectric IRD detector, manufactured by KUBE Electronics Limited. The infrared detector 112 is in data communication with the processor 120 and the input controller 122 of the unit 100. In an example embodiment, the infrared detector 112 senses motion on the lateral sides of the unit 100, including areas outside of the range or scanning area of the ultrasonic detector 110. As the user moves in front of the unit 100, the opposing sensors of the infrared detector 112 start to receive substantially equal signals from the user. As the ultrasonic detector 110 may emit an audible clicking at close range, such as when the user is standing directly in front of the unit, the ultrasonic sensor 110 may be temporarily disabled when a user is directly in front of the unit. The exemplary combination of an ultrasonic detector 110 and an infrared detector 112 permits a detection proximity range for individuals of approximately 20 feet to the right, left and forward of the unit 100.

The unit 100 includes input circuits 122 which suitably include operation amplifiers, buffers, and hard logic circuitry to convey information from the input devices such as the ultrasonic detector 110, and the infrared detector 112 into a format readable by the processor 120. In this example, further input devices include a 4-button input keyboard 131, and a microphone 132. The microphone 132 is adapted to receive audible inputs from a user or customer near the unit 100 involved in the entertainment sequence. The input circuits 122 may include voice recognition circuitry 133. By way of example and not limitation, the voice recognition circuitry includes a Voice Direct protoboard from Sensory, Inc. The Voice Direct protoboard permits identification of five or more predetermined messages. This exemplary voice recognition protoboard recognizes parts of phrases spoken by the customer or user. The recognition of parts of phrases allows the recognition circuit to be tolerant of background conversation, or when people speak with drawls or foreign dialects in the English language. The recognition of parts of phrases also allows some background noise, as long as one or two words of the recognized phrase are received by the recognition circuitry. The triggered recognition circuit produces a unique set of binary pulses for each recognized message. The binary pulses are sent to a decoder where they are converted into a serial stream of pulses. A processor based look-up table may also determine from the customer's voice, for example, a possible ethic background of the customer user, and/or if the customer is male or female, or a child.

The input microphone 132 suitably may include a Panasonic noise canceling microphone no. P9897.

The processor 120 is also in data communication with output circuits 124. The output circuits 124 provides outputs to a speaker 135 and display lights 136. By way of example, but not limitation, the output speaker 135 for the unit 100 suitably may be an 8 ohm speaker such as a Panasonic GAS-G12D531E2. The output circuits 124 may include a low power, low distortion, amplifier for sound output to the user or customer, as controlled by the processor 120. The output circuits 124 may also control display lights 136.

The processor 120 is in data communication with data storage 126. Data storage 126 stores steps to be followed by the processor 120 and also stores information concerning the user or customer. This information may include the customer's or user's moves, or play pattern in the game sequence, and/or user or customer identifying information or characteristics, from the inputs of the ultrasonic and infrared detectors 110 and 120, and the microphone 132. Customer identifying information may include the customer's name as provided to the unit by alphanumeric or verbal input devices, or from outside sources. Customer characteristics suitably may include direct inputs to the unit sensors, or statistical or numerically processed biometrical results from such inputs, such as from the detectors 110 and 120, and the microphone 132.

The storage device 126 in this exemplary embodiment includes a playback chip 138 holding high quality audio messages for audio playback by the system. By way of example, but not limitation, the playback chip 138 includes an ISD 1400 playback chip, manufactured by ISD, Inc., holding up to two minutes of high quality audio messages. A message delivery circuit in the output circuit 124 provides for the entire outgoing message to be played before a second message is triggered.

In an exemplary embodiment, the unit 100 includes a remote product illuminator 170. The processor 120 of the game unit 100 is in data communication with a wireless transmitter 160 in communication with a wireless receiver 173 in data communication with the remote product illuminator 170. The remote product illuminator 170 includes a relay 171, which triggers an illumination device 175 which can illuminate a product 195 remote from the game unit 100 as part of a game sequence. The user or customer may be directed to the illuminated product 195 as part of the game sequence run by the game unit 100. Other circuits suitably may be triggered by the relay 171, as desired.

In this exemplary embodiment, the unit 100 is in data communication with a printer 180 adapted to print coupons or award certificates.

The game unit 100 suitably is powered by a battery 150 recharged by a photovoltaic unit 152. This exemplary game unit 100 is designed for low power consumption to be charged by ambient lighting in a store setting. This permits operation of the unit without battery replacement or plug-in to the house 110 volt wiring at game unit location.

In the example shown in FIG. 2, the game unit 100 is also in data communication with a transmitter 140 and a receiver 142 for communications with a remote computer or parent processor 190. By way of example, but not limitation, the transmitter 140 suitably may include a LINX TXM916 transmitter, and the receiver 142 may include a LINX RXM916 receiver, both manufactured by Linx, Inc. The transmitter 140 and receiver 142 permit digital communications with a remote computer, such as a personal computer receiving signals from a similar transmitter and receiver pair connected to the remote computer's RS232 serial port.

FIG. 3 is a front view of the exemplary game unit 100 of FIG. 2. The components of the game unit 100 are installed in an enclosure 102 with a front 105. Mounted in the front 105 of the unit 100 are the output speaker 135 and the 4-button keyboard 131. The input microphone 132 is also mounted in the front 105 of the unit 100, permitting verbal inputs to the unit 100. The infrared detector 112 is mounted in the front 105 of the unit 100, with the opposing sensors of the infrared detector 112 facing toward the lateral sides of the front 105 of the unit 100. The ultrasonic detector 110 is mounted within an end of an approximately 1.5 inch diameter PVC pipe section inset into the front 105 of the unit 100, placing the detector 110 approximately one inch back within the pipe section from the front 105. As a result, the ultrasonic detector 110's has a ‘view’ outward at an angle of approximately 45° to either side of the front 105 of the unit 100.

The unit 100 is configured to be connected to a modular transmitter and receiver 140/142 such as described with reference to FIG. 2 above. The unit 100 may be connected to a photovoltaic cell 152 for powering the unit 100. The unit 100, in this exemplary embodiment, is attached to a pressure sensor unit 184. The pressure sensor unit 184 suitably may measure pressures applied by product 185 on a shelf proximal to the unit 100. The unit 100 is also in data communication with a coupon or award certificate printer 180 that prints awards or certificates for the user participating in the game sequence run by the unit 100.

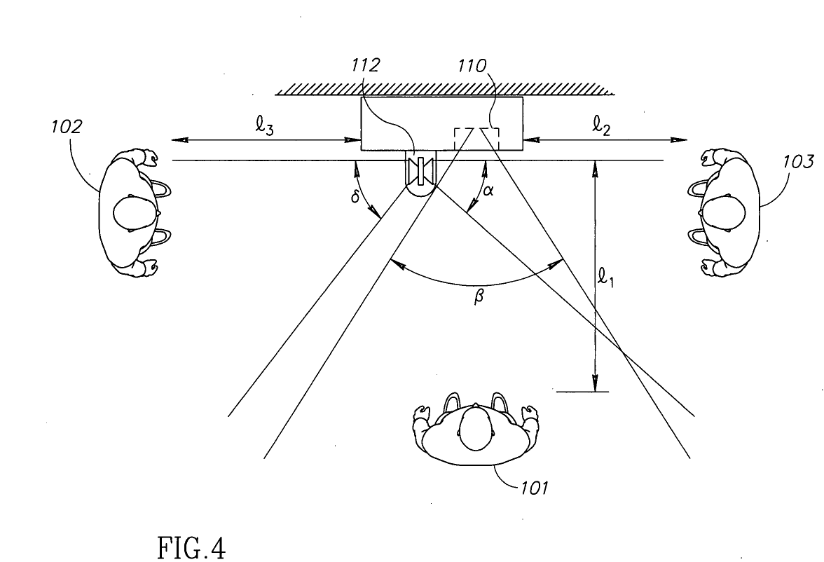

FIG. 4 is a top view of the exemplary game unit 100 of FIG. 2 mounted to a vertical surface. In front of the unit 100 is a first customer 101, to the left of the unit is a second customer 102, and to the right of the unit 100 is a third customer 103.

The ultrasonic detector 10 has a detection range 11 towards the front of the unit of approximately 30 feet, and a detection angle β of approximately 90°. The infrared detector 112, mounted with the infrared sensing elements facing laterally and opposed to each other, has a right detection distance l₂ of approximately 20 feet, and a right detection angle α of approximately 85°, a left detection distance l₃ of approximately 20 feet, and left detection angle δ of approximately 85°. Monitoring of the outputs from the ultrasonic detector 110 and the infrared sensor detector 112 over time permits a determination by the system that customer is to the right, left, and center of the unit, and a determination that the customer is approaching, stationary, or departing.

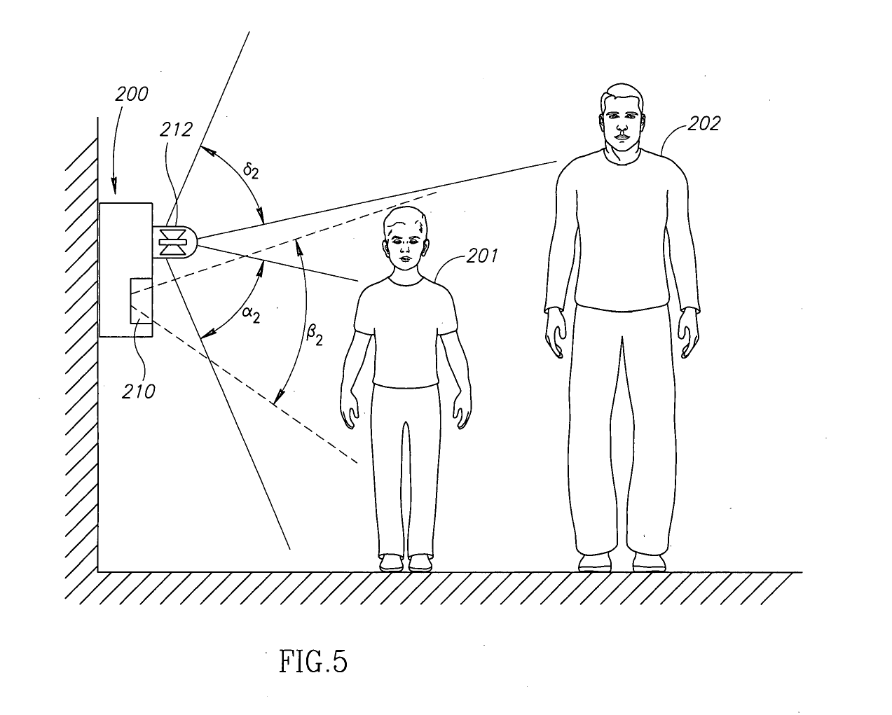

FIG. 5 is a diagram of an alternate game unit 200 mounted to a vertical surface, set up to categorize users or customers according to height, thus differentiating between a child 201 and an adult 202. In the alternate game unit 200, the infrared sensor 212 is mounted, for example, at approximately head level of an average 10 year-old child, with the separated sensing units facing upward and downward. The upward portion senses an angle above the horizontal from the unit 200 angle of δ₂ equal to approximately 60° and below the horizontal at an angle of approximately α₂ of approximately 60°. An ultrasonic detector 210 has a detection angle β₂ of approximately 45° centered on the horizontal, sensing both a child 201 and an adult 202. A child 201 triggers only the lower sensing element of the detector 212 while an adult 202 triggers both sensing elements of the infrared detector unit 212.

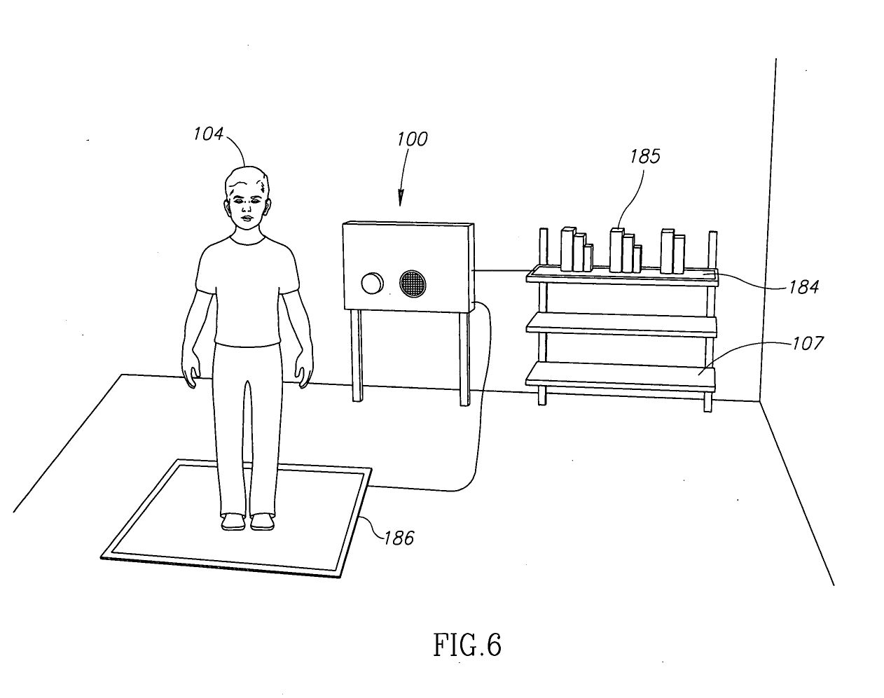

FIG. 6 is a pictogram of an exemplary installation of a game unit such as the game unit 100 of FIG. 2, mounted on a vertical surface in a store setting. A customer 104 approaching is sensed by the unit 100. Adjacent to the unit 100 is a shelf 107 including the pressure sensor 184. The pressure sensor 184 measures weight on the shelf 107 from a product 185. For example, when the customer 104 may be directed to pick a particular product in connection with a game sequence run by the unit 100, the pressure sensor 184 senses the lifting of the product 185. An alternate pressure sensor may include a sensor 185 on a surface such as a floor, sensing the weight or footsteps of the customer 104.

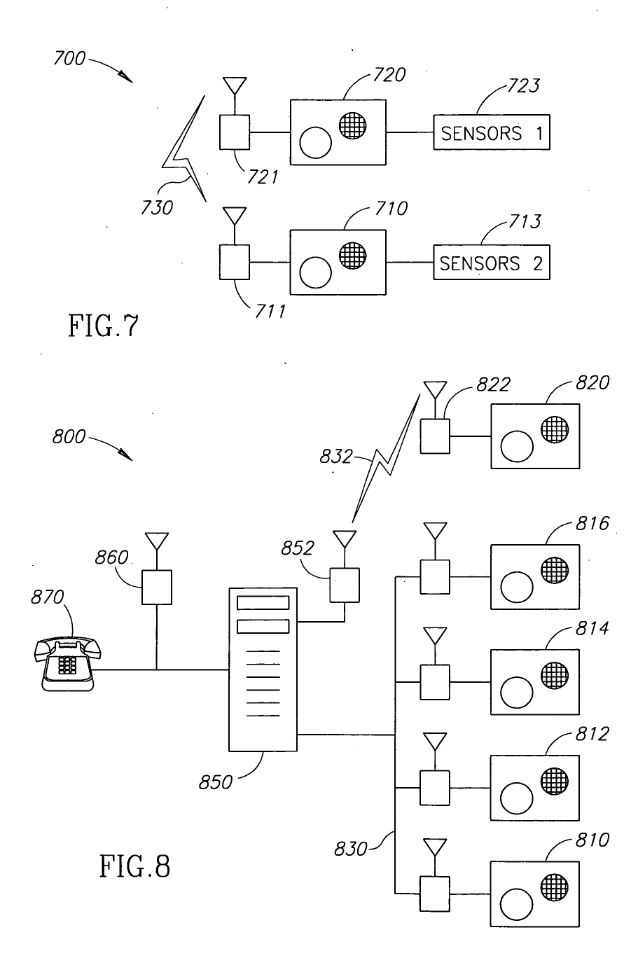

FIG. 7 is a component drawing of a 2-unit interactive marketing system 700 in accordance with an embodiment of the present invention. A first unit 720 includes a game unit, such as described with reference to FIG. 1 or 2 above, in data communication with a first set of sensors 723 and a transmitter/receiver pair 721. The first unit 720 can thus communicate wirelessly through wireless communications 730 to a second unit 710 similarly in data communication with a transmitter/receiver pair 711, and a second set of sensors 713. The two units can perform entertainment sequences involving game steps by a user in interaction with the first unit 720 and the second unit 710, typically at two separate locations at two separate times.

Turning to FIG. 8, it can be appreciated that a plurality of game units such as those described with reference to FIGS. 1-7 above, may be in data communication with a parent processor, in accordance with an embodiment of the present invention. A multi-unit game augmented interactive system 800 is shown, by way of example, but not limitation, including a parent processor 850 linked by cable 830 to four game units 810, 812, 814, and 816 at different locations at a facility (not shown). The parent processor 850 is also linked wirelessly through a transmitter/receiver pair 852 and a wireless link 832 to a transmitter/receiver pair 822 in data communication with a fifth game unit 820 at another location near or at the facility. It will be appreciated that any suitable combination of wireless and wired links may link the game units with each other and the parent processor 850. The parent processor 850 in data communication with the five game units 810, 812, 814, 816, and 820 facilitates central gathering, tallying or compiling of information related to users and customers, and/or the user's or customer's game steps from a predetermined game sequence. Tallying is maintaining a count of the referenced event or information, while compiling includes storing information such as customer information and the steps taken by the customer. The parent processor 850 suitably may be in data communication with other facilities by longer range wireless transmitter receiver system 860 or by telephony 870.

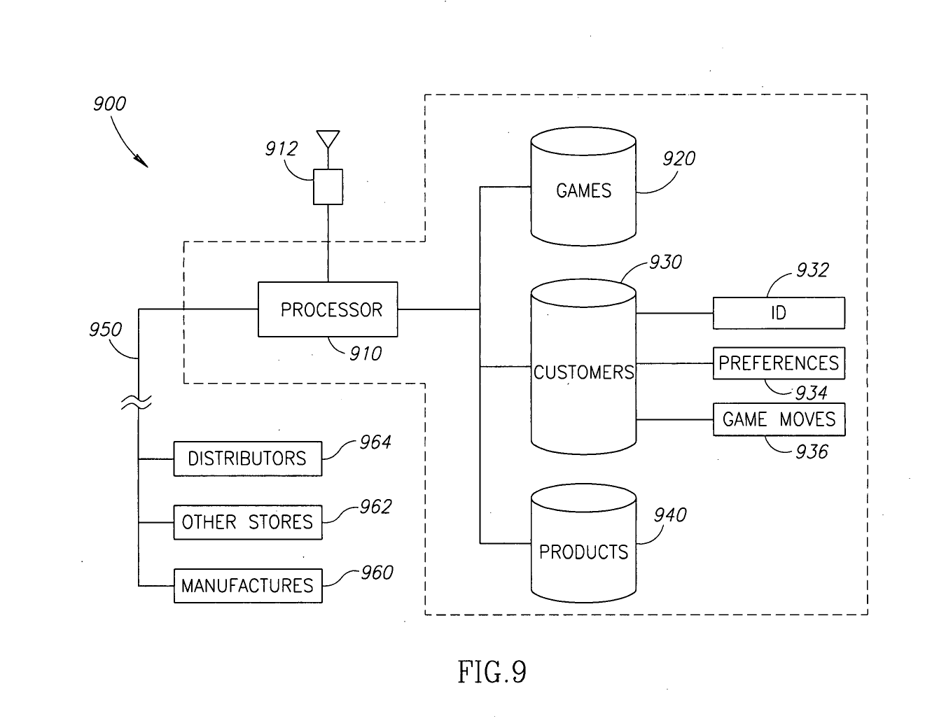

FIG. 9 is a component drawing of an exemplary parent processor 900 in accordance with an embodiment of the present invention. The parent processor 900 includes a central processor 910, such as a computer processor running a WINDOWS operating system, or an open source operating system. In data communication with the processor 910 is a database 920 storing game steps, and a database 930 storing customer information, including, by way of example, customer identification data 932, preferences 934 and game moves 936. The processor 910 is also in data communication with a product database 940 including information about particular products for use in connection with the game sequence being run by the parent processor 900. This example parent processor 900 includes a transmitter/receiver pair 912 for wireless links to game units within a few hundred yards of the parent unit 900. The parent unit 900 suitably may be linked by computer network 950 to product distributors 964, other stores or facilities 962, or product manufacturers 960, for remote control of the entertainment sequence being run in part by the parent unit 900, and/or for downloading of information relating to game status, users, and tallies of verified information segments or product-related advertising impressions delivered to the users or customers involved in the entertainment sequence.

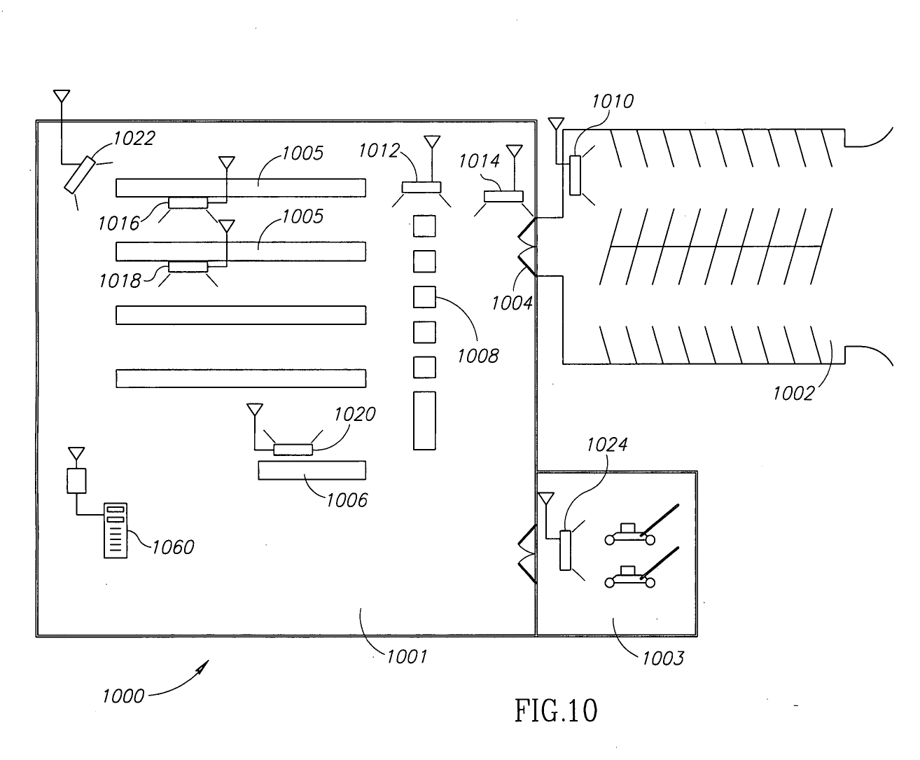

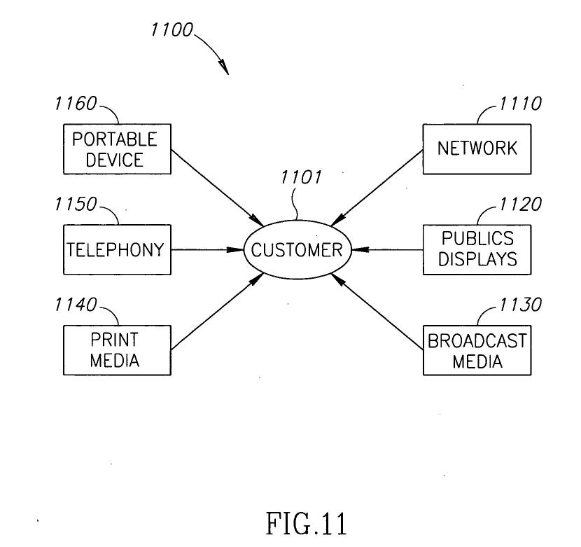

FIG. 10 is a plan view of a facility 1000, such as a store, with a plurality of game units 1010, 1012, 1014, 1016, 1018, 1020, 1022, and 1024, and a parent processor 1060, linked wirelessly. In this example embodiment, the facility 1000 includes a store area 1001, a parking lot 1002, and a specialty outside sales area 1003. A game unit 1010 is installed in the parking lot near the entrance 1004 to the store 1001. By way of example, but not limitation, the parking lot game unit 1010 may detect the proximity of a user or customer and announce the presence of an ongoing game sequence in the facility 1000. An entry game unit 1014 may run other steps in a game sequence. A checkout unit 1012 may suitably scan for particular products or interact with customers during checkout in accordance with a game sequence. An overhead unit 1022 may operate a game sequence in an area of the store, or track users, as may units 1016 and 1018 mounted to store shelves 1005. A unit 1020 mounted to a specialty shelf 1006 may direct game play related to specialty products at the specialty shelf 1006. A game unit 1024 in the exterior display area 1003 may direct game play related to products in the exterior area, such as, for example, lawnmowers.

Each of the game units 1010 through 1024 is in wireless communication with the parent processor 1060, tallying or compiling user information, game moves, and exchanging other information in connection with the game sequences being run at the facility 1000. It will be appreciated that game units such as game units 1010-1024 may be positioned at any suitable location at any facility, either inside or outside, to facilitate the entertainment sequence(s) being run by the system.

FIG. 11 is a component drawing of an exemplary information distribution system 1100 in accordance with an embodiment of the present invention. A customer 1101 suitably may receive game or entertainment sequence information from a plurality of public or semi-public sources. The customer 1101 may obtain game play or sequence information from a computer network 1110, from public displays 1120, and/or from broadcast media 1130. The customer 1101 may also obtain information related to the game play or sequence from print media 1140, through telephony 1150, such as by calling an information number. The customer 1101 may also obtain information through a portable device 1160 carried or transported by the customer 1101. By way of example, but not limitation, such portable devices 1160 may include cell phones, portable computers, handle-held computing or communication devices, toys, or electronic inserts in products.

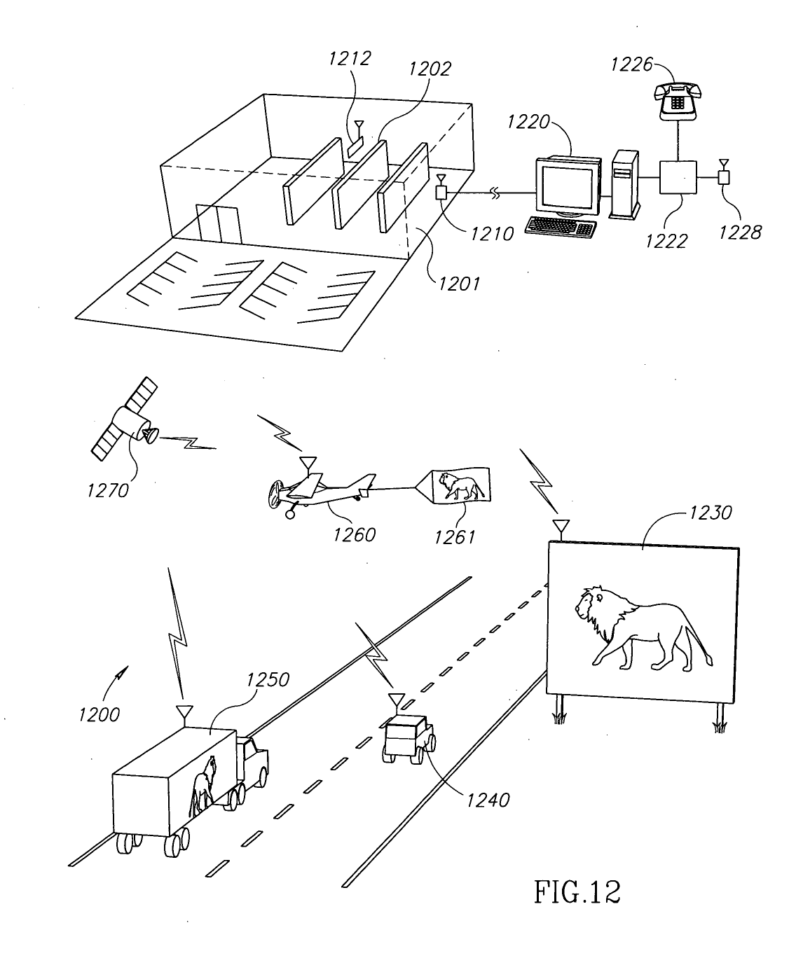

FIG. 12 is a pictogram of a multi-modal game augmented interactive marketing system 1200 in accordance with an embodiment of the present invention. A parent processor 1220 runs a product-related entertainment sequence. The parent processor 1220 is in data communication with a communications controller 1222. The controller 1222 is in data communication with a telephone input line 1226 and to a transmitter/receiver 1228. The processor 1220 may be in data communication with outdoor advertising 1280, such as an active display billboard 1230, a vehicle mounted display device 1250, such as that mounted on the side or rear panels of a truck, and/or an aircraft 1600 mounted or towed aerial display 1261. A user (not shown) in the user vehicle 1240 driving along the roadway either sees the vehicle mounted display 1250 or the billboard 1230 and obtains an information key for use and play in the entertainment sequence run by the parent processor 1220. (An information key is a set of data that may be recognized at the specific location, such as a password or code word or sequence. A token is a physical object or representation that the user may physically carry to a specific location to be recognized, or marks, such as punches on a card, stamps on a user hand or other object, may be provided to the user in other sequences.) The user (not shown) may call in on the phone line 1226 to obtain an additional information key or keys for play in the entertainment sequence, with the user's contemporaneous location near the billboard 1230 or the vehicle mounted display 1250 verified by global positioning data from a GPS (global positioning system) 1270 incorporated in the cell phone signal. The vehicle mounted display 1250 location at any time also may be verified by global positioning data from the GPS 1270.

A store 1201 includes a store processor 1210 linked wirelessly to a game unit 1212 mounted to a shelf 1202. Upon entry into the store 1201, the user may interact with the game unit 1212 by taking a step in the entertainment sequence facilitated by or including transmittal of the information key received by the user from the billboard 1230 or vehicle display 1250. The entertainment sequence being run by the system 1200 thus uses multiple modes of communication, and engages the user upon entry into the store 1201.

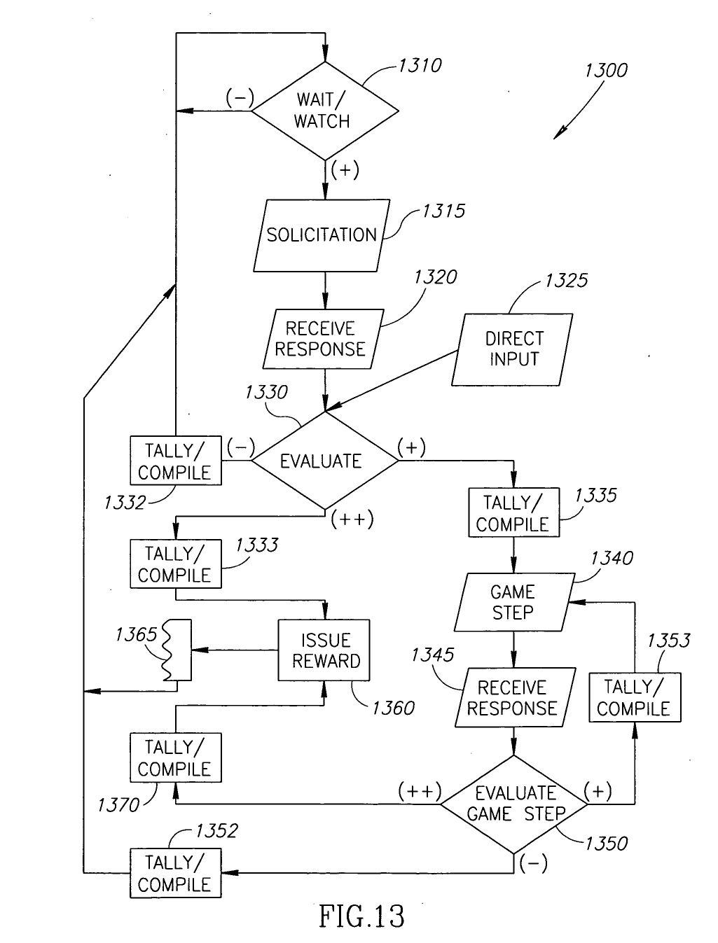

FIG. 13 is a flowchart of an exemplary entertainment sequence or game 1300 in accordance with an embodiment of the present invention. At a block 1310 a game system (not shown) waits and watches for users or customers. If no user or customer is present, the unit continues to wait and watch at the block 1310. If a customer user is sensed at a block 1315, a solicitation in accordance with the game sequence being run by the system is presented to the user or customer. The user or customer provides a response received at a block 1320 (which response may include a null or no response). At a block 1330, the system evaluates the response. In this exemplary embodiment, the evaluation involves a determination to whether the customer or user has an outside information key or token permitting the direct release of a reward at a block 1360. Where no identifiable response is presented the system returns to wait and watch at the block 1310, after having tallied or compiled at a block 1332 the delivery of the solicitation to the user. Where the system determines that the customer or user has provided a response consistent with entering into game steps, the system proceeds to those game steps at a block 1340.

The sequence 1300 thus provides an opportunity for the customer/user to approach the system, and make a direct input at a block 1325 not responsive to the solicitation made at block 1315 which direct input may be related to immediately receiving a reward at block 1360. The direct input 1325 may come from alternate modes of game play, such as the remote game play described with reference to FIG. 12 above. If the user provides the proper direct input, the system then tallies the positive result (e.g. the customers recitation of the desired message or information key) at a block 1333 and issues a reward at a block 1360. In one embodiment, the reward is issued by printing a reward certificate at block 1365.

If the response of the customer at a block 1320 or the direct input of the customer 1325 is unintelligible, but a response has occurred, further steps such as at a block 1340 in the game play or entertainment sequence are required prior to an award. The system tallies (keeps count of) or compiles (stores with other customer information) the indication of response by the customer at a block 1335 and then proceeds with a further game step 1340 eliciting a response from the user or customer at a block 1345. The response is evaluated for a positive or negative response at an evaluate game step block 1350. A directly positive response is tallied or compiled at a block 1370 and a reward is issued at the block 1360. A negative or insufficient response at the evaluate game step block 1350 returns the system to wait and watch at the block 1310, after tallying or compiling at a block 1352 the delivery of the game step to the user. A response at the evaluate game step block 1350 consistent with continuing further steps in the game sequence leads to a tally or compilation of the game move status at a block 1353, and a return to further game steps at the block 1340. By way of example, but not limitation, the input from the user may include push button access on a game unit such as that described with reference to FIGS. 1 and 2 above. An example game sequence that may be utilized following the flowchart of FIG. 13 and a single game unit such as described with reference to FIG. 2 is as follows:

The customer approaches; the unit, waiting and watching at the block 1310 senses the customer. At a block 1310, a solicitation is issued by the unit (the following numbers, e.g. 13A, label example dialogue segments or steps for reference only to aid discussion herein of dialogues and alternates):

13A: Unit: “Good morning. Do you see any product made by Company ABC?”

The customer may respond as follows:

13B: Customer: No response; or 13B′: Customer: “Yes”; or

13B″: Customer: “They're superb.

At the block 1330, evaluation of these responses leads to returning to waiting and watching at a block 1310 for a no response; to continue game play through the “yes” response; and to issuance of a reward at a block 1360 for a direct input of “they're superb.” The “yes” response is tallied at the block 1335, and the direct input response “they're superb” is tallied at a block 1333 reflecting that the customer or user has (a) actually seen a product of customer ABC, or (b) knows a slogan of Company ABC, respectively.

At the further game step 1340, the game unit states:

13C: Unit: “Pick-up the Company ABC product you like best.”

Customer response is as follows:

13D: Customer: No pick-up; or

13D: Customer: Pickup of a Company ABC product.

At the evaluation block 1350, if no product is picked up the system returns to wait and watch at a block 1310, after tallying or compiling the step level of the user at a block 1352. If a product is picked up a tally or compilation is made at a block 1370 of the customer user choice, and a reward is issued at a block 1360.

Alternately, the further game step 1340 could be as follows:

13E: Unit: “Great! Company ABC brings wonderful products to your home. Tell us, which of these products [or which product package] do you like the most?

The system then lights either simultaneously or in sequence three products.

The customer responds:

13F: Customer: No response/no recognizable response; or

13F′: Customer: “Product A.”

At the evaluation block 1350, a positive evaluation leads to a tally or compilation at a block 1370 and a reward at a block 1360, and a no response returns the system to waiting and watching at the block 1310. The positive response, by way of example, reflects information normally derived from a focus group. The derived information measures real time product-user interaction typically producing more reliable data than obtained in a virtual or artificially created environment found with traditional focus groups. The experience of the user at the location of the unit also enhances and lengthens the point of sale, or point of product interaction, when a purchase decision may be made by a user or customer.

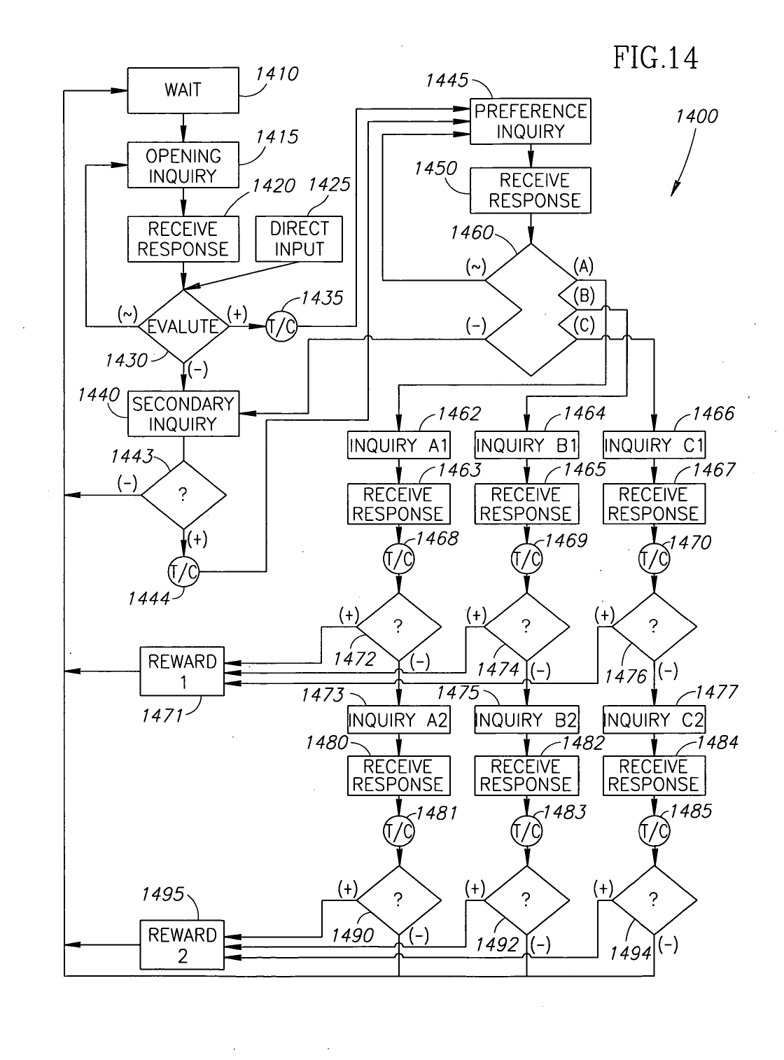

FIG. 14 is a flowchart of a preference game 1400 in accordance with an embodiment of the present invention. At a block 1410, the entertainment sequence waits. Upon detection of a customer or user at a block 1415, the system makes an opening inquiry to the customer user. At a block 1420, the customer or user responds to the opening inquiry. Alternately, a direct input from the approaching user or customer may be provided at a block 1425. At a block 1430, the response or direct input is evaluated. An undecipherable response repeats the opening inquiry at a block 1415. A negative response from the user or customer results in a secondary inquiry at a block 1440. A positive response evaluated at block 1430 leads to a tally or compilation 1435 of the positive response and the system proceeding at a block 1445 to a preference inquiry.

The second inquiry to the user at the block 1440 is evaluated at a block 1443. A negative response returns the system to wait at a block 1410. A positive response moves the system to the preference inquiry at the block 1445, while the positive response is tallied at a block 1444. The preference inquiry at block 1445 requests a choice preference among three choices A, B, and C. The customer provides a response at a block 1450, which is evaluated at a decision block 1460. If the response is undecipherable, the preference inquiry is repeated at the block 1445. If the response is negative or a desire is indicated to end the sequence, the system proceeds to a secondary inquiry at the block 1440. Otherwise, the customer has successfully chosen between choices A, B, and C. Preference response A leads to inquiry A1 at a block 1462, and response B to an inquiry B1 at a block 1464, response C to the inquiry C1 at a block 1466. The customer responds to inquiry A1 at a response block 1463. The customer responds to inquiry B1 at a response block 1465, and the customer responds to inquiry C at a response block 1467. The fact of a response being given to inquiry A1 at a block 1462 is tallied at a block 1468. The fact of a response being made to inquiry B1 at the block 1464 is tallied at a block 1469. The fact of a response being given to inquiry C1 at block 1467 is recorded at block 1470.

The customers response to inquiries A1, B1, or C1 are evaluated at decision blocks 1472, 1474, and 1476, respectively. A positive response to any of these inquiries leads to a Reward No. 1 at a block 1471. An incorrect or negative response at the decision blocks 1472, 1474, and 1476 leads to a follow-up inquiries A2, B2, and C2 at blocks 1473, 1475, and 1477, respectively. Inquiries A1 and A2 relate to the A preference given in response to the preference inquiry at the block 1445 above. Inquiries B1 and B2 relate to the B response given in response to the preference inquiry at the block 1445 above. Inquiry C1 and C2 relate to the C response given in response to the preference inquiry at the block 1445 above. Responses to inquiries A2, B2, or C2 are given at blocks 1480, 1482, 1484, respectively. The fact of response being given to inquiries A2, B2, or C2 are tallied at blocks 1481, 1483, and 1485, respectively. Each of the responses to inquiry A2, B2, and C2 are evaluated at decision blocks 1490, 1492, and 1494, respectively. Positive responses lead to a Reward no. 2 at a block 1495. Undecipherable responses to each inquiry set A1 and A2, B1 and B2, and C1 and C2, respectively return the system to wait at a block 1410.

By way of example, but not limitation, the exemplary dialogue operating under entertainment sequence listed in FIG. 14 may be as follows: At block 1415 the unit issues an opening query:

14A: Unit: “Good morning. Do you want to play a game regarding. Company ABC?”

The customer responds at block 1420:

14B: Customer: “Yes”; or

14B′: Customer: Direct input by pushing a button; or

14B″: Customer: “They're superb;” or

14B′″: Customer: “No;” or

14B″″: Customer: -Unintelligible-.

If the response is unintelligible, the system returns to block 1415 or alternately asks:

14C: System: “Would you like to try and get a coupon for product X?”

A “no” response returns the system to block 1410.

If the customer response is yes, a tally or compilation of the customer impression of Company ABC name is made at block 1435. The game continues with the preference inquiry at block 1445:

14D: Unit: “Of Company A's products, which do you like best? Product A, B, or C?

The customer responds at block 1450:

14E Customer: “Product A” (block 1450).

The unit then asks the first A series query A1 at block 1462:

14F: System: “Was product A introduced in 1950, 1960, or 1970?”

The customer responds at block 1463:

14G: Customer: “1960.”

The system tallies customer preference A and a second exposure to the product A name at the block 1468.

If the customer response evaluated is correct at a decision block 1472, the system states:

14H: Unit: “That's correct;”

and issues Reward no. 1 at block 1471.

If the response given is incorrect, the system gives a back-up inquiry at block 1473:

14G: Unit: “That's close, but the correct answer was ______ (thereby educating the customer as to product history)]. You can still get a coupon if you name the main advertising character for product A. Name that character”.

The customer gives a response at block 1480.

14H: Customer: “Alfred the penguin.”

The answer is evaluated at block 1490. If correct the system responds, for example:

14I: Unit: “Correct. Here is your coupon.” (Block 1495)

Similar questions suitably may be asked and responses tallied with respect to products B and C in the other chains of the process 1400 of FIG. 14.

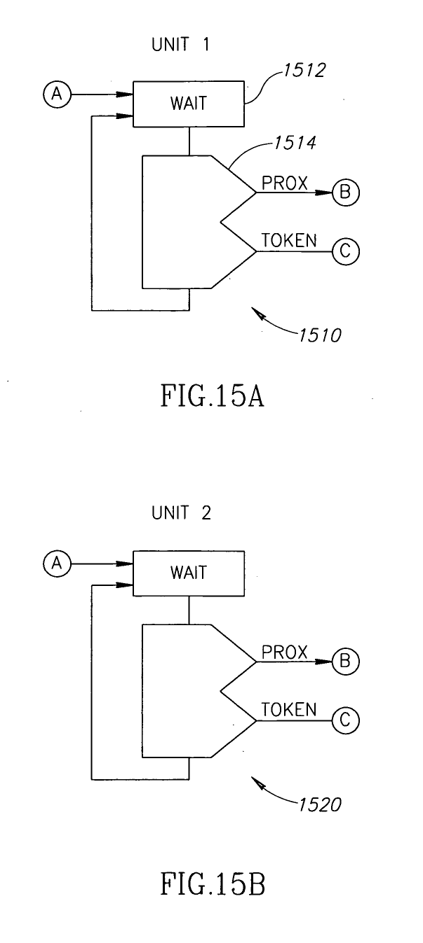

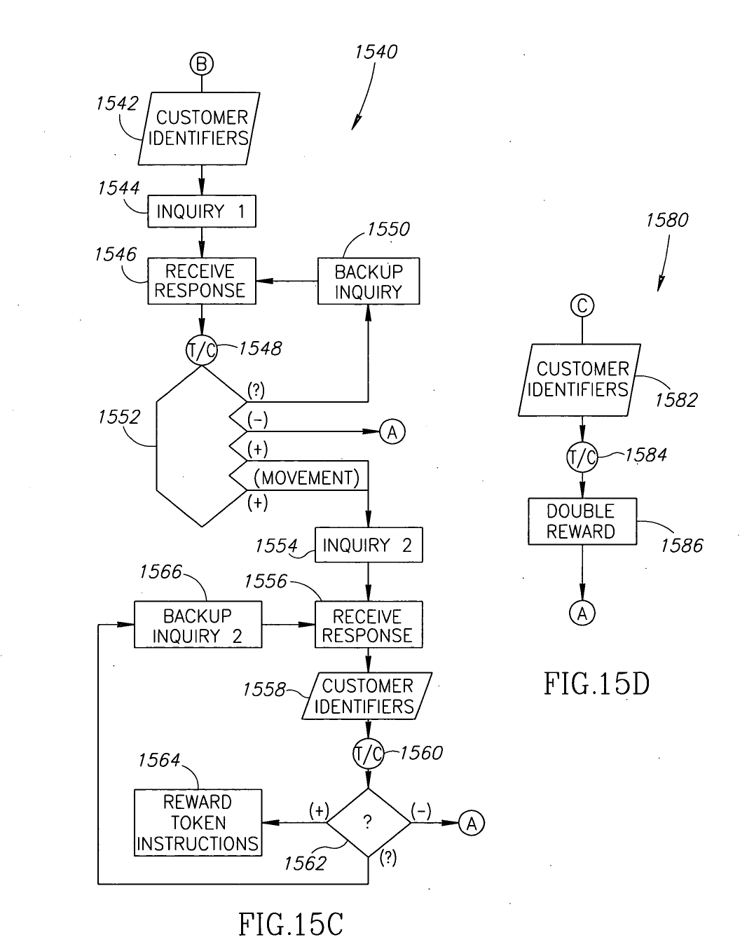

FIGS. 15A, 15B, 15C, and 15D are flowcharts for an exemplary two advertising unit game in accordance with an embodiment of the present invention. FIGS. 15A and 15B reflect the basic waiting and evaluation subroutine 1510 run by first adverting unit, Unit 1, and a second advertising unit, Unit 2, respectively.

FIG. 15C reflects a flowchart of a process 1540 run by either Unit 1 or Unit 2 when a customer is detected in proximity of Unit 1 or Unit 2, but does not have a customer token or information key.

FIG. 15D reflects a flowchart of a process 1580 run by either Unit 1 or Unit 2 when approached by a customer with a token or information key.

In FIG. 15A, Unit 1, running, process 1510, labeled Subroutine A, waits at a block 1512 listening for a user or customer or waiting for a customer or user to approach. The customer's actions are evaluated at a decision block 1514. If customer is sensed in proximity to Unit 1, without a token or information key, Unit 1 jumps to Subroutine B, which is the process 1540 of FIG. 15C described below. If the customer approaches and speaks the predetermined information key or demonstrates possession of a predetermined token, at a decision block 1514, Unit 1 jumps to subroutine C, the process 1580 described with reference to FIG. 15D below.

The process 1520 run by Unit 2 while waiting and watching as shown in FIG. 15B, labeled Subroutine A, is identical to that for Unit 1 in FIG. 15A above. At a block 1512, Unit 2 waits and listens. At a decision block 1514, if the customer approaches in proximity, but does not have a token or key, Unit 2 jumps to Subroutine B, process 1540 in FIG. 15C. If the customer approaches with the token or information key, Unit 2 jumps to Subroutine C in FIG. 15D.

In FIG. 15C, Subroutine B, process 1540 as noted, is run by either Unit 1 or Unit 2, the unit having detected the proximity of customer or user without a token or information key. At a block 1542, the unit inputs customer identifiers such as walking speed and infrared signature. At a block 1544, the unit issues an opening inquiry. The customer responds at a block 1546. The customer's response is tallied or compiled at block 1548. The customer's response is evaluated at a block 1552. If the response is unintelligible or questionable, the system responds with a backup inquiry at block 1550 and gives the customer an opportunity to respond at a block 1546. If the customer response indicates a negative interest in continuing with the entertainment sequence, the system returns to Subroutine A as described with reference to FIG. 15A or 15B above. If the customer's verbal response is positive or if the customer's movement is positive, the system responds with inquiry no. 2 at a block 1554. The customer responds with a response at block 1556. Customer identifiers, such as one or more biometric characteristics, are stored at a block 1558. Biometric characteristics, such as customer voice frequency and infrared signature, are a measurements derived from an aspect of the individual or the individuals behavior. The customer's response is tallied at a block 1560. The response is evaluated at a block 1562; if the response is positive, the customer is given a reward token or information key and instructions to take that item or information key to the product area near the other advertising unit at a block 1564. If the response is unintelligible, the system asks a back-up inquiry no. 2 at block 1566 and returns for response at block 1556. That response is evaluated in decision block 1562. If negative, the system returns to the waiting and monitoring Subroutine A in FIG. 15A or 15B.

FIG. 15D reflects Subroutine C, process 1580, run by either Unit 1 or Unit 2 when a customer approaches with the identifiable token or information key given out at block 1564 of Subroutine B of FIG. 15C. At a block 1582, the customer identifiers, or biometric characteristics are taken. The customer's presenting of the token or key is tallied or compiled at block 1584 reflecting the customer's use of the token or key. At a block 1586, the customer receives a double reward for the customer having first gone to one unit and then gone to the other. The system returns to Subroutine A of FIG. 15A or 15B to wait or watch for other customers. Using the customer identifiers, if the customer has already received a double reward, the double reward is not issued at block 1586.

Example dialogue sequences for the 4A entertainment sequence running the subroutines of FIGS. 15A, 15B, 15C, and 15D, by way of example and not limitation, are as follows:

The customer approaches Unit 1 and is sensed to be in proximity to the unit without speaking the information key, at decision block 1514 of FIG. 15A. Jumping to Subroutine B, process 1540 of FIG. 15C, customer identifiers are taken at a block 1542. The system issues its inquiry no. 1 at block 1544:

15A: System: “Good afternoon. Either say or find your favorite cereal product of Company ABC to have with strawberries.”

At a block 1546, the customer responds:

15B: Customer: Moves to or says: “Cereal Z”.

A response indicating a desire to end the game would return the unit to subroutine A in FIG. 15A or 15B. An unintelligible response leads to a back-up inquiry at block 1550:

15C: System: “For double discount, are you interested in telling us your favorite Company A cereal with strawberries?”

The system would return to block 1546. A now positive response or detected movement toward cereal X leads to the second inquiry at block 1554:

15D: System “Can you state the slogan for cereal X?”

The customer responds at block 1556:

15E: Customer: “They are superb.”

The system samples the customer's voice frequency, or otherwise acquires customer identifying information at the block 1558 and tallies or compiles the fact that the customer has stated the slogan for product X, and has moved towards or mentioned product X, confirming the customers receipt of marketing impressions including these marketing elements.

The customer's response is evaluated at a decision block 1562. A negative response returns the system to subroutine A of FIG. 15A or 15B above. A positive response leads to the system providing the reward token or information key (to carry to the other unit) and instructions at the block 1564:

15F: System: “That's correct. For a double discount coupon, go to the strawberries [location of other unit] and say aloud: ‘Product X is superb with strawberries.’”.

If the response evaluated at block 1562 is unintelligible, a back-up inquiry is presented by the system at block 1566:

15G: System: “Do you know the slogan for product X? If so, please say it again.”

The system then returns to listen for a response at the block 1556, as above.

In FIG. 15D, now at the other unit, the customer approaches, and at block 1514 provides the information key:

15H: Customer: “‘Product X is superb with strawberries.”

The receiving other unit then jumps to Subroutine C of FIG. 15D where customer identifiers are taken at a block 1582, including the customer voice frequency, which is checked to make sure the customer will not be receiving multiple discount rewards. At a block 1584, the customers' stating of the product name is tallied as representing a product impression. At block 1586, the double discount coupon for both strawberries and product X is issued. The system then returns to Subroutine A of FIG. 15A or 15B to listen for the approach of another customer.

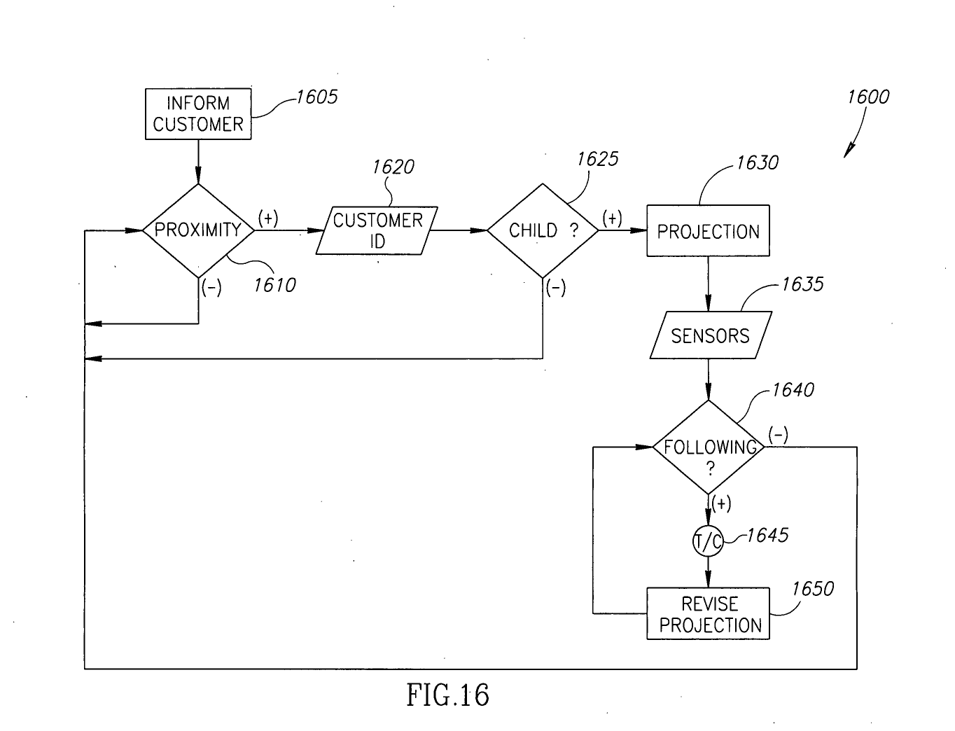

Turning to FIG. 16, a flowchart of an exemplary projection game 1600 for children of the present invention is presented. At a block 1605, the customer is informed that they are entering a game zone location, in other words a facility where interactive marketing game play is in process. The step of informing the customer at block 1605 suitably may be done by signs or announcements, but may also be undertaken by a game augmented interactive marketing unit such as that described with reference to the figures above. By way of example, but not limitation, such a unit may sense the proximity of a customer, inform the customer they are in an area where game plays available and inquire if the customer needs further information.

At a decision block 1610, now within a specific game area, a game augmented interactive marketing unit waits and senses for the proximity of a customer. If no customer is present, the unit continues to wait. If a customer is sensed at a block 1620, customer identifier information is recorded by the unit. By way of example, the identifying information suitably may include height information and voice frequency information. At a decision block 1625, a decision is made by the unit as to whether a child is present. If a child is not present, the unit returns to wait for a child at decision block 1610. If a child is present, at a block 1630, the unit initiates a series of projections such as by way of example pointing to a floor hopscotch area with product logos.

At a block 1630, the unit may also inform the child of the game opportunities:

16A: System: “Follow the lights for a quick hopscotch game.”

At a block 1635, the unit monitors the child for movement consistent with the projection. At a decision block 1640, an inquiry is made as to whether the child is following the projection series. If a child is not following the projection series, the system returns to waiting for the proximity of a customer at block 1610. If the child is following the projection sequence, at a block 1645 the system tallies the customer's receipt of the logo impressions pointed out by the projection system. At a block 1650, the unit revises the projection consistent with the game presented. At block 1650, the system may also provide additional audio outputs to a child, such as a jump-rope rhythm type of song or product associated sounds educationally reinforcing the product impressions, and may include further inquiries by the unit and responses by the customer, such as:

16C: System: “Do you want to play again?”

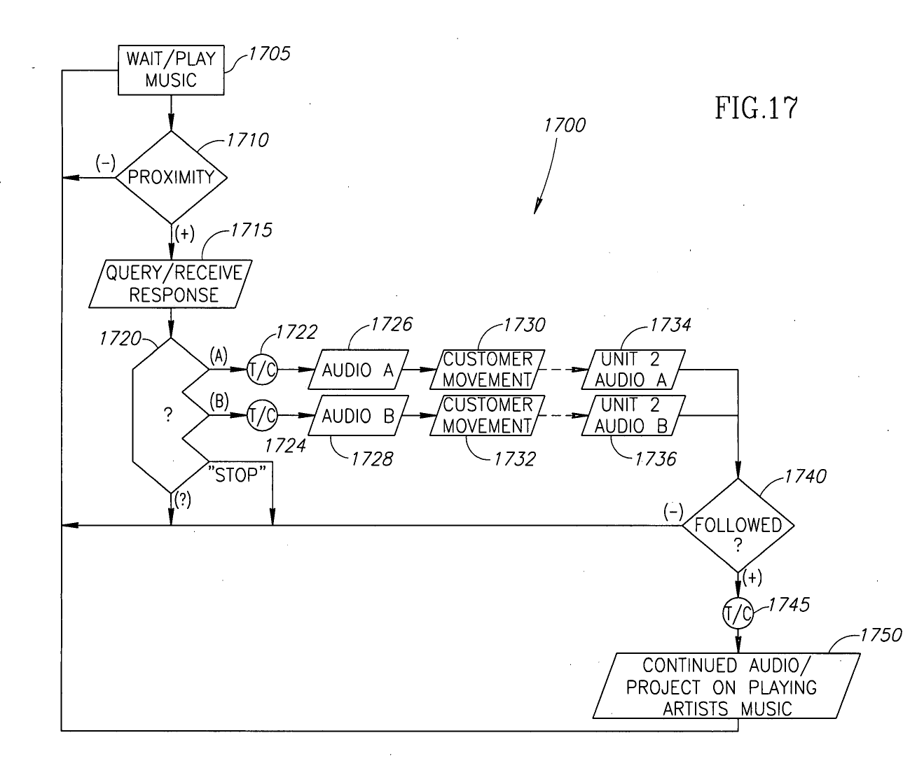

FIG. 17 is a flowchart for a musical audio movement game 1700 in accordance with an embodiment of the present invention. At a block 1705, one or more game augmented interactive marketing units play music and wait for the approach of customer at a facility. At a decision block 1710, the system determines whether a customer has entered into the proximity of the unit. By way example, if the unit is at a music section of a store, the unit may sense that the customer is to the right of the unit or to the left of the unit, and may change the music being played accordingly in that local area. At a block 1715, the unit makes an inquiry to the customer and inputs a response from the customer.

For example, the system may inquire:

17A: System: “Hey, you're looking at the country music section. I can play you background clips from artist A or artist B. Which would you prefer?”

The customer response may be for the system to stop or may be unintelligible, evaluated at a decision block 1720, such as:

17B: Customer: “Stop;” or

17B′: Customer: Unintelligible/moving away.

These response result in the system returning to continue to play background music and wait for other customers at a block 1705.

If the customer requests artist A, such as by saying:

17B″: Customer: “I like artist A;”

That request is identified at decision block 1720.

At a block 1722, customer identifier data is tallied and the customer's statement of the artist name as registering the impression of the artist name is recorded for reporting to the music distributor. At a block 1726, the system switches to playing music from artist A. At a block 1730, the customer movement is monitored and as the customer moves through the store, at a block 1734, another unit approached by the customer, unit 2 commences to play audio of artist A at block 1734. The second game augmented interactive marketing unit also monitors the movement of the customer. If the customer moves toward the unit following the music, at a decision block 1740, the customer identifiers are tallied and the customer's following of the stated audio is tallied as a marketing impression. At a block 1750, the system continues to play the customer preferred audio.

The system, at a block 1750, may also illuminate a music item of the preferred artist product with word outputs and/or customer rewards:

17C: System: “[Preferred artist's] new recording under the lights is the one that is playing. ‘Do you want a $1.00 discount coupon for that CD?”

The unit may take other steps consistent with the present invention, ultimately returning to the block 1705 to play background music and sense for other customers.

Alternately, at the decision block 1720, the customer may respond at a block 1715 with a response indicating a preference for artist B:

17B′″: Customer: “My favorite is artist B.”

The system then tallies customer identifiers and the customer statement of the artist B's name as a marketing impression. At a block 1728, the system begins playing music for artist B and monitors the customer movement at block 1732. An adjoining game augmented marketing unit 2, as the customer approaches, also plays audio for music B and the process 1700 continues, as described above, with the inquiries and continued audio relating to preferred artist B instead of preferred artist A.

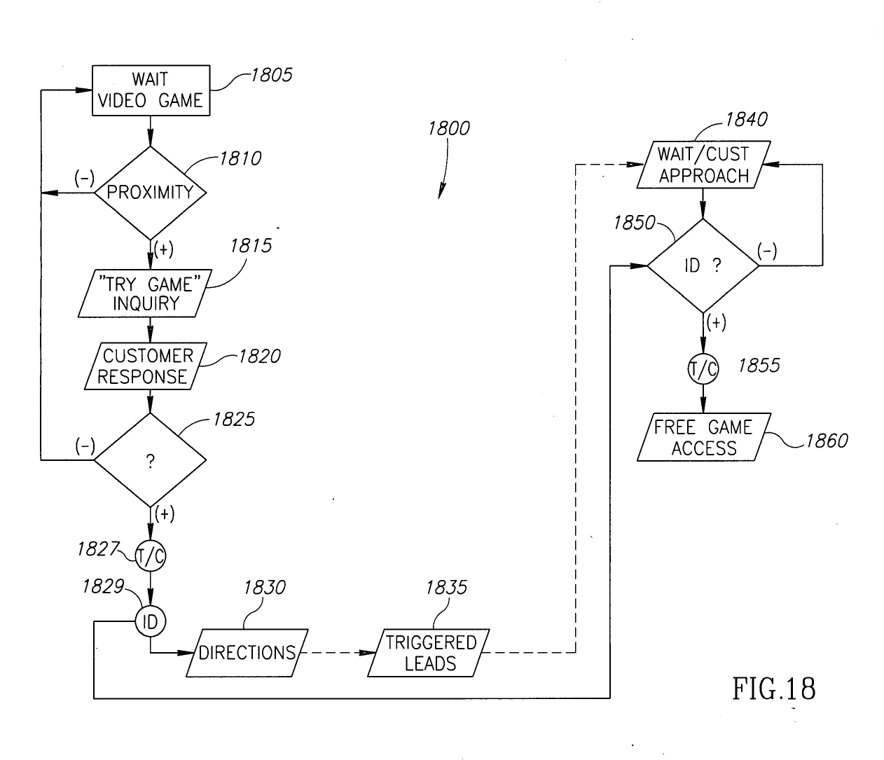

FIG. 18 is a flowchart of an exemplary ‘lead-to’ entertainment sequence 1800. At a block 1805, such as a kiosk in a facility, waits and plays and shows scenes from a video game JKL on a screen. At decision block 1810, the kiosk including a game augmented marketing unit senses for the proximity of the customer. Upon the approach of a customer, at an output block 1815, the system inquires of the customer:

18A: System: “Would you like to try a free 10 minute play of video game JKL?”

At a block 1820, the customer responds:

18B: Customer: “Sure.”

With the positive response, the system tallies the customer's receipt of the impression of the initial game video clip at a block 1827, and at a block 1829 intakes customer identifiers, such as voice frequency information, height, or infrared profile.

If at the decision block 1825 the customer's response is negative or unintelligible, the system returns to waiting and playing video game clips at the block 1805.

With a positive response, after the tallying and identifying of the product impression and the identification of the customer, the unit provides directions to the free video game at an output block 1830:

18C: System: “Follow the arrows the free JKL game player that store MNO.”

The unit then triggers, “Lead-to” arrows or other indicators at output block 1835, providing directions for the customer. The indicators may be broadcast by other game units detecting the proximity of the customer, identifying the customer, providing audio encouragement, and providing further directions, or simply may be readily identifiable triggered screen displays or flashing lighted indicator arrows. Customer identification information taken at the block 1829 suitably may be provided to such units for identifying the customer during the journey to store MNO. Customer identification suitably may include different levels of identification, as desired for game or sequence accuracy. For example, in a store setting, an identification level of a person as being more likely than not the same person among the limited population in the store at the referenced time may be sufficient for a coupon issue game, while identifying the person by name may be desired for a more elaborate sequence, or one that involves delivering an item of some value to one specific person. Authentication includes the process of matching acquired biometric characteristics of the user with previously saved biometric data related to the user.

At store MNO, at a block 1840, another game augmented interactive marketing unit waits for the customer's approach, having received customer identifier information taken at the block 1829.

At a decision block 1850, the store MNO unit waits to identify the customer. If the customer is not identified as one coming from the solicitation kiosk, the system remains in waiting mode, or plays other programs or entertainment sequences at block 1840. If the customer is identified at block 1850 as having recently been directed by the kiosk, the customer's receipt of and positive response to the invitation, itself a marketing impression of the game is tallied at a block 1855.

The unit at store MNO then provides free game access at a block 1860:

18D: System: “Welcome. We appreciate your interest in game JKL. Touch the screen to start your 10-minute free play of game JKL.”

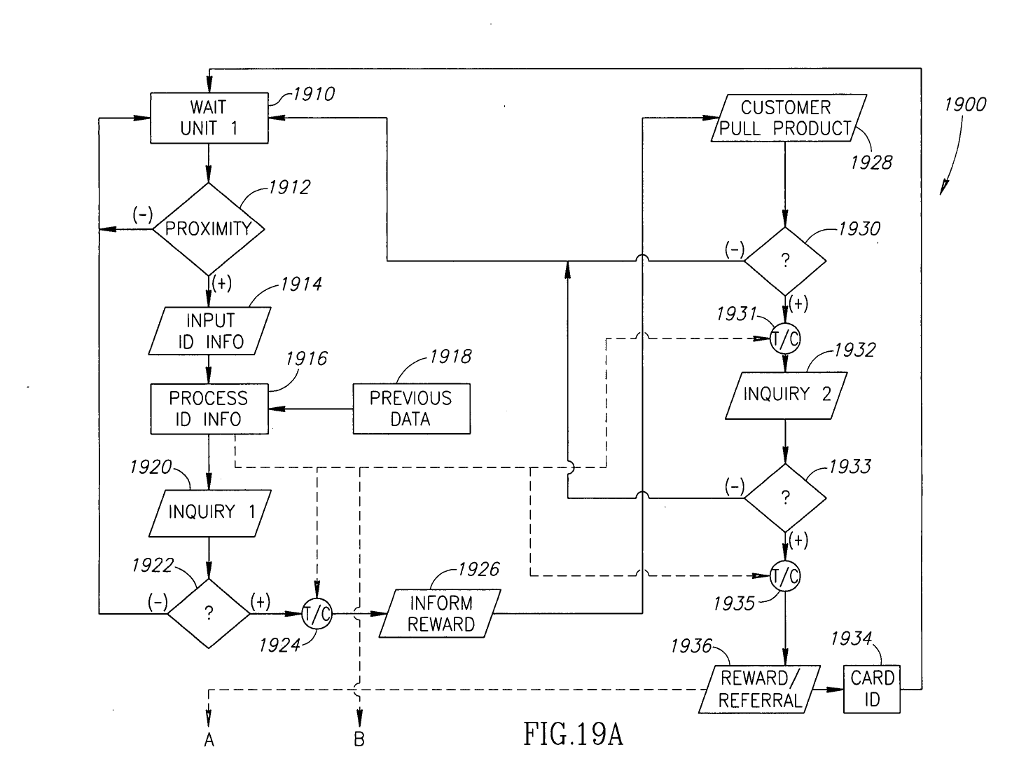

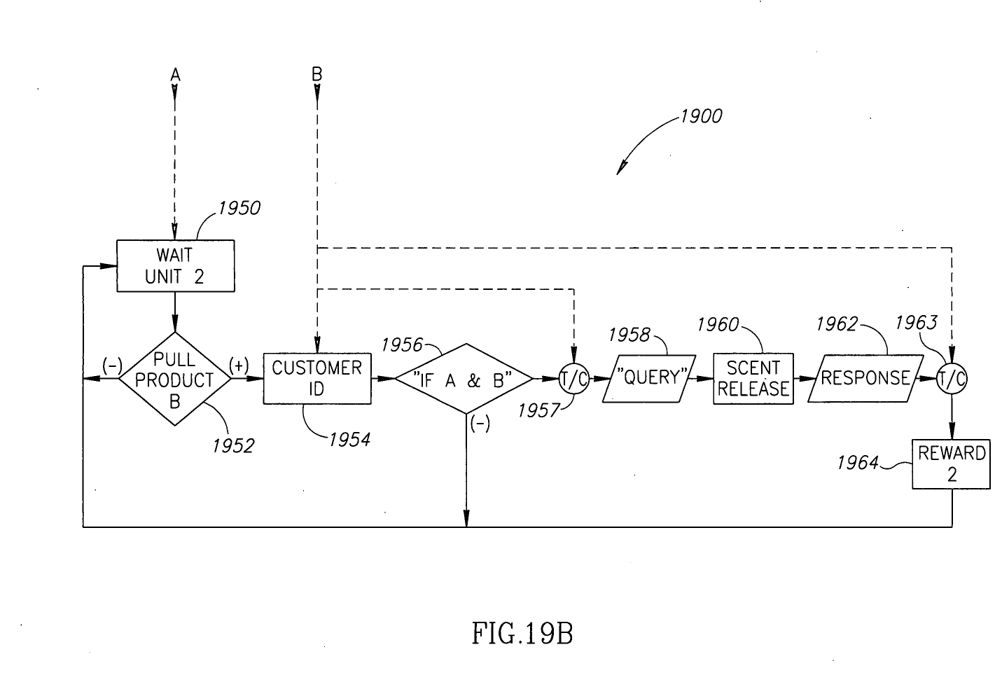

FIGS. 19A and 19B present a flowchart of an exemplary double product game 1900 in accordance with an embodiment of the present invention. At a block 1910, a first interactive game marketing unit awaits the presence of a customer. At a decision block 1912, the system evaluates whether a customer is in proximity with the unit. If no customer is present, the unit continues to wait at block 1910. If the customer is sensed, at a block 1914, the system inputs customer identifier information taken in by sensors of the system. At a block 1916, the unit processes the sensor information into a customer identifier. This process may include data previously taken, such as that acquired by the units at that facility at a block 1918, during previous visits of the customer to the facility. Once identifier information is processed, such as, by way of example, but not limitation, identifiers in the customer's spectrophotometric profile or voice frequencies are called out and that information is forwarded to other units and is available customer identification on subsequent visits. The customer identification data suitably may be stored on a parent unit at the facility, or by storage at the unit itself. The customer information may also be forwarded to central storage for the entire store chain, or to manufacturers or distributors that have placed game augmented interactive marketing units near specific products in particular facilities.

With the identifiers, at a block 1920, unit 1 proceeds with the first inquiry to the customer:

19A: System: “Good morning. Answer some questions regarding ACME lunchmeat for a double reward with bread purchase, okay?”

At a decision block 1922, the customer response is evaluated. If negative, the system returns to wait at block 1910. At block 1924, if the customer's response is positive, the impression of the product name is tallied with identifying information from block 1916.

The customer is informed of the reward at a block 1926:

19B: System: “Correct answers lead to $3.00 off ACME lunchmeat and a loaf of bread. Please pick up ACME lunchmeat.”

At a block 1928, the customer lifts up the ACME lunchmeat product. At a decision block 1930, an evaluation is made as to whether the customer has picked up the product. If not, the system returns at a block 1910 to wait.

If the customer has picked up the lunchmeat, the system tallies the customer impression of the ACME lunchmeat product at block 1931, and proceeds with a second inquiry at a block 1932:

19C: System: “Sing [or say] the ACME lunchmeat jingle.”

The customer response is evaluated at a block 1933. If the customer does not state the jingle, the system returns to wait at the block 1910. If the customer response is positive such as:

19D: Customer: [Singing/saying] “I love ACME for lunch,”

The positive response of the customer is rewarded with a further referral by the first unit at a block 1936:

19E: System: “Go to the bread section and lift up QRS bread. If you only want ACME lunchmeat, say ‘credit now’ and swipe your courtesy card for a lunchmeat only credit. Otherwise, go to the bread section for your full $3.00 off coupon.”

If the lunchmeat only credit is requested the customer's courtesy card ID is received, and the unit returns to wait at the block 1910. For the customer moving on to the bread section, identifier and move information is transferred to a unit 2 at the bread section awaiting customers at a block 1950.

If the response to the second inquiry is unintelligible at the evaluation block 1933, the unit 1 returns to waiting at the block 1910.

It will be appreciated that alternately to singing the ACME jingle, the system could ask the user to read information from the package, such as describing ingredients or flavorings of the package contents, or other information from the packaging of the product.

If the game augmented unit 2 senses QRS bread being lifted from the shelf at a decision block 1952, the second unit proceeds with customer identification at block 1954. Otherwise, the unit 2 continues to wait at the block 1950.

If at a decision block 1956 the customer is identified as the customer having picked up the lunchmeat, the customer's identification and marketing impression of bread QRS is tallied at a block 1957. Unit 2 then proceeds with the follow-up query at block 1958:

19F: System: “Hey, you have ACME lunchmeat and QRS bread. Are you a sandwich and soup fan?”

At a block 1960, the unit 2 releases the scent of minestrone soup and awaits a response. At a block 1962, the response is tallied at a block 1963, which if positive, is stored with the customer identifiers for later solicitations for soup, by way of example. At a block 1964, the unit 2 issues the $3.00 ACME lunch/bread coupon.

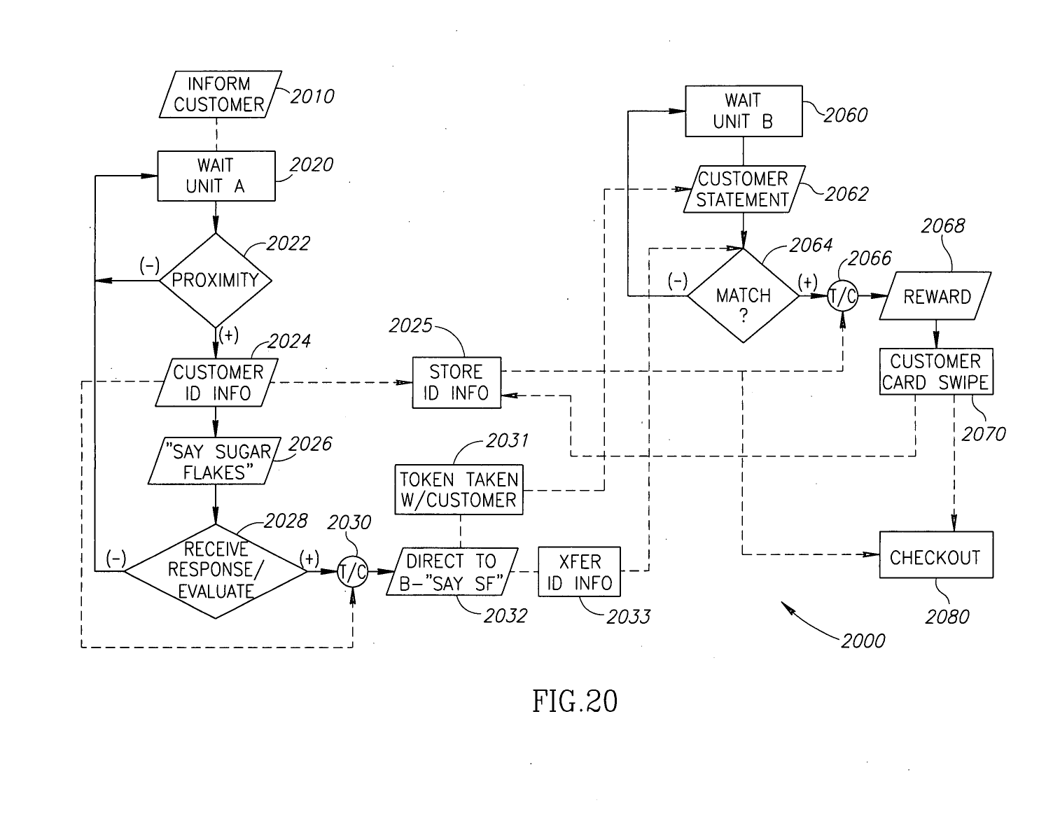

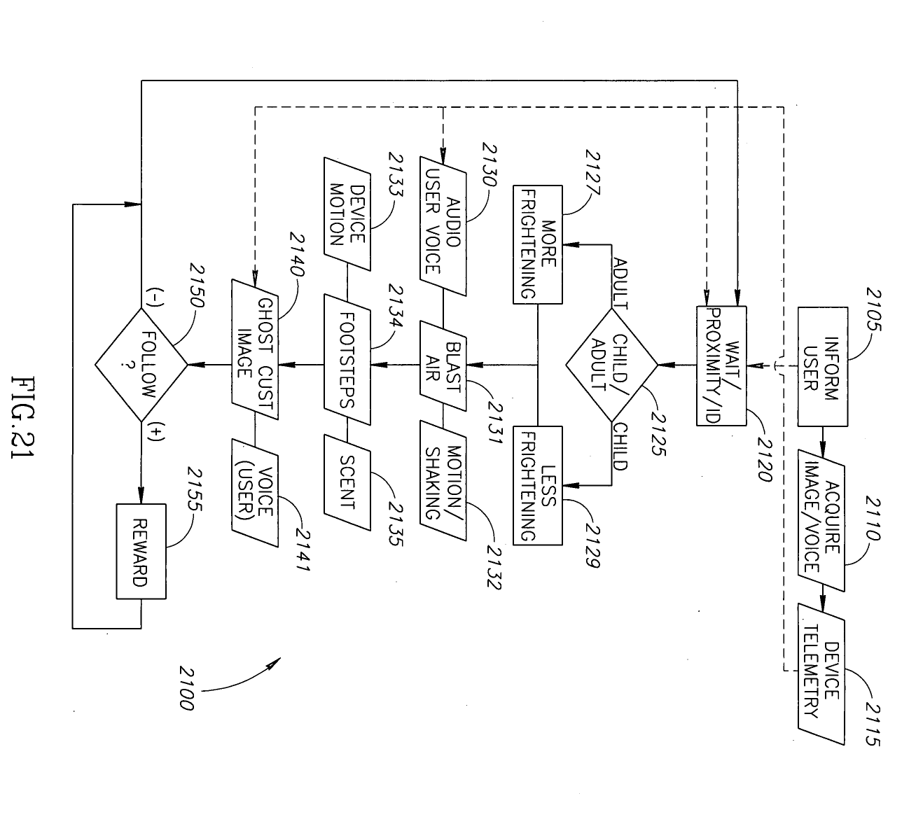

FIG. 20 is a flowchart of an exemplary product jingle game 2000 in accordance with an embodiment of the present invention. At a block 2010, the customer is informed of the availability of an interactive game playing zone. The customer may be suitably informed interactively through an interactive game unit, or through announcements or signs. The customer may be informed of available game and locations other than at the facility where the game is being played.

At a facility, an interactive game unit A waits at a block 2020. At a decision block 2022, the unit determines whether it senses the proximity of a customer. If no customer is sensed, the unit continues to wait at the block 2020.

If a customer proximity is sensed, customer identification information is input by the system at a block 2024. The customer identifier identification is then stored at a block 2025 for access by other units and for the system at other steps in the process 2000.

The unit, by way of example, but not limitation may be situated near a cereal section of a grocery store. The unit makes an initial voice request to the customer a block 2026:

20A: System: “Good morning. Say ‘Sugar Flakes’!”

At a decision block 2028, if the customer's response is negative or if there is no response, the unit A returns to awaiting a sensing status at the block 2020.

The response by the customer may be positive:

20B: Customer: “Sugar Flakes.”

The system tallies the response to the customer reflecting the product impression of the product name “Sugar Flakes” at a block 2030, and the customer impression is logged with the customer ID information acquired at the block 2024.

At a block 2032, the system directs the customer to proceed to another area of the store, such as the milk area for a discount, together with special information:

20B: System: “For a free quart of milk, go immediately to the milk section and say, ‘Susan sells sugar flakes and milk at the seashore.’”

The system has thus given an information key, the words “Susan sells sugar flakes, etc.” to the customer for the customer to carry to a waiting interactive game unit B at the milk aisle of the store. At a block 2033, unit A sends the customer's identifier information to unit B, now with information that the customer has been delivered the information key at the block 2032.

At the separate store location, or even at a separate facility, a game augmented interactive marketing unit B waits at block 2060. The customer arrives and makes a statement to the unit at a block 2062:

20C: Customer: “Susan sells sugar flakes and milk at the seashore.”

At a decision block 2064, the unit B checks for a match of the customer statement with the predetermined token or information key being utilized by the game, and selects and determines whether the customer at unit B has indeed previously been at the sugar flakes location by checking customer identification information transferred at the block 2033. If there is no match, the unit B returns to a waiting sensing mode at the block 2060.

If there is a match, the customer's receipt and repeating of the product impression “sugar flakes” is tallied at a block 2066, and a reward is issued to the customer at block 2068:

20D: System: “Congratulations, you get a free quart of milk. Please swipe your card and take your free milk to the check-out; it will be logged as free when you check out.”

At a block 2070, the customer swipes a magnetic stripe customer preference card. The customer's name is stored with the identifying information gathered by unit A and unit B at the block 2025. A name and the customers prior customer preference card is now in data communication with the customer identifier information for later use, and at check-out at block 2080, the customer receives an credit for the free quart of milk when the customer card is again swiped.

FIG. 21 is a flowchart of a haunted house entertainment sequence 2100 in accordance with an embodiment of present invention. At a block 2105, the customer is informed by an interactive game unit that a haunted house entertainment sequence is in process. The unit acquires a visual image of the customer, and a voice clip of the customer at a block 2110 by interacting with the user. At a block 2115, by telephony or other system, the user's identification, image, and voice are transmitted to other units involved in the haunted house entertainment sequence.

At a block 2120, by way of example, but not limitation, at a location remote from the original informing of the customer at block 2105 and acquiring information regarding the user at block 2110, an interactive game unit waits, and senses the proximity of a user and identifies the user as previously entering the entertainment sequence. At a decision block 2125, the unit determines whether a child or an adult is present by voice characteristics or height. If a child is present at a block 2129, the system shifts to less frightening modes, while if an adult is present, at a block 2127, the unit shifts to more frightening modes. At a block 2131, the system triggers or emits actions following a haunted house sequence such as a blast of air at block 2131, motion or shaking at a block 2132, spooky audio utilizing the customer's voice characteristics at a block 2130, incorporating customer voice characteristics acquired at the block 2110. The sequence continues with the sound of footsteps running off in a particular direction being emitted by the system at a block 2134, triggering of animatronics devices at a block 2133, and the emission of musty scents at a block 2135.

At a block 2140, a ghost image of the customer is projected running away. The customer image includes visual aspects of customer acquired at the block 2110.

The system also triggers or emits further voice instructions in the voice of the customer at a block 2141:

21A: System [in customer voice]: “You must follow me!”

At a decision block 2150, the system senses whether the user is following the customer ghost image. If the user is not following, the system returns to waiting at the block 2120. If the customer follows, the customer is led to a reward release destination at a block 2155. The system then returns to wait at the block 2120.

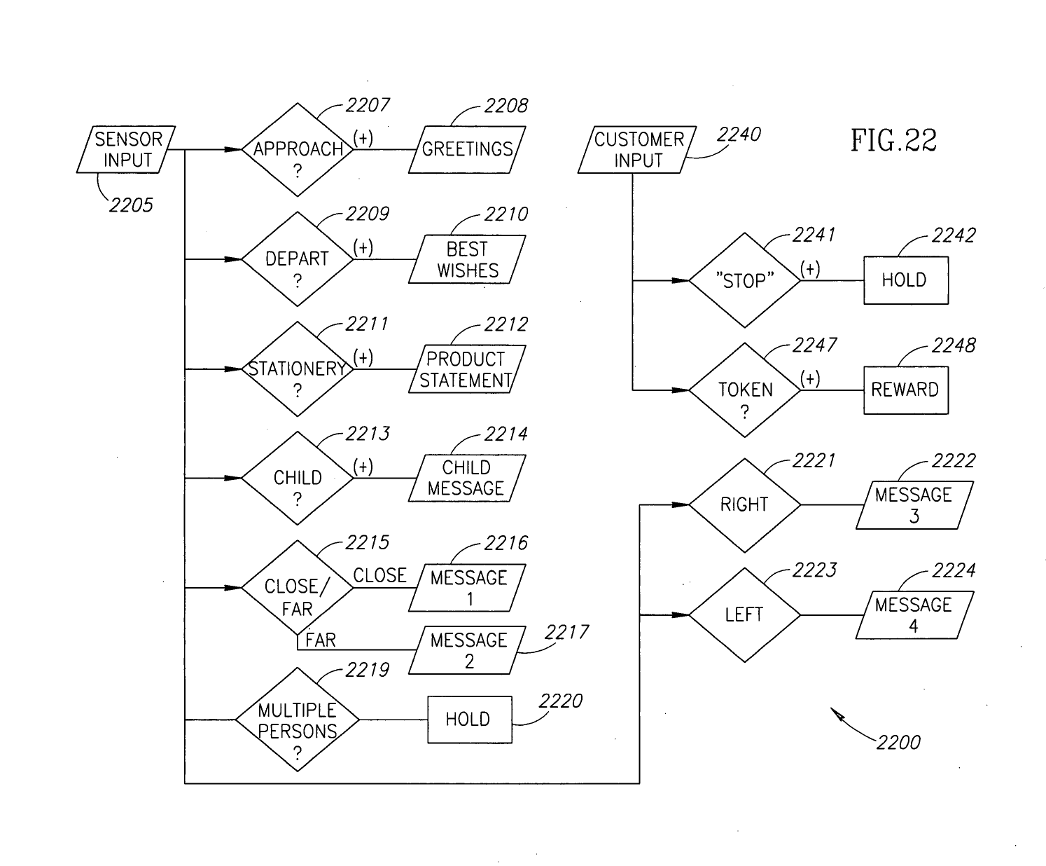

Turning to FIG. 22, exemplary decision-making steps of a game augmented interactive marketing decision tree 2200 are shown in flowchart form. At a block 2205, sensors of a unit or several units input information concerning the proximity, motion and characteristics of a user. By way of example, but not limitation, at a decision block 2207, if the customer is approaching, initial greetings may be offered at a block 2208. At a decision block 2209, if the user is departing, the system issues a departing system at block 2210, such as “best wishes.”

If at a decision block 2211, the customer is stationary near the unit, the system suitably may issue a statement concerning a product near the unit at a block 2212. At a decision block 2213, if the system determines a child is present, a child structured message is delivered at a block 2214.

At a decision block 2215, if the unit or units detect the user is close or far, the system provides a message no. 1 at a block 2216 for the customer being close to the unit, and a message no. 2 at a block 2217 for the customer being farther away. For example, message 1 may be not as loud as message no. 2.

If the system at a block 2219 determines multiple persons are present, and the system does not have the capability to divide or categorize a group of people, the system may place a ‘hold’ on any further outputs at a block 2220.

Similarly, by way of example, if the system determines that the user is to the right of the unit at a block 2221, the system may issue a message no. 3 at a block 2222. If the system determines that the user is to the left of the unit at a block 2223, the system may deliver a message no. 4 at a block 2224.

Parallel with the sensor input, the system may input verbal or other information direct from the customer at a block 2240. For example, if the customer says, “Stop”, at a decision block 2141, the system then transfers to a ‘hold’ status at a block 2242.” Alternately, if the customer input indicates the holding of a token or information key, at a block 2247, the system may issue a reward at a block 2248. It will be appreciated that a number of units or a single unit in sequence may follow a combination of the steps and decisions in process 2200.

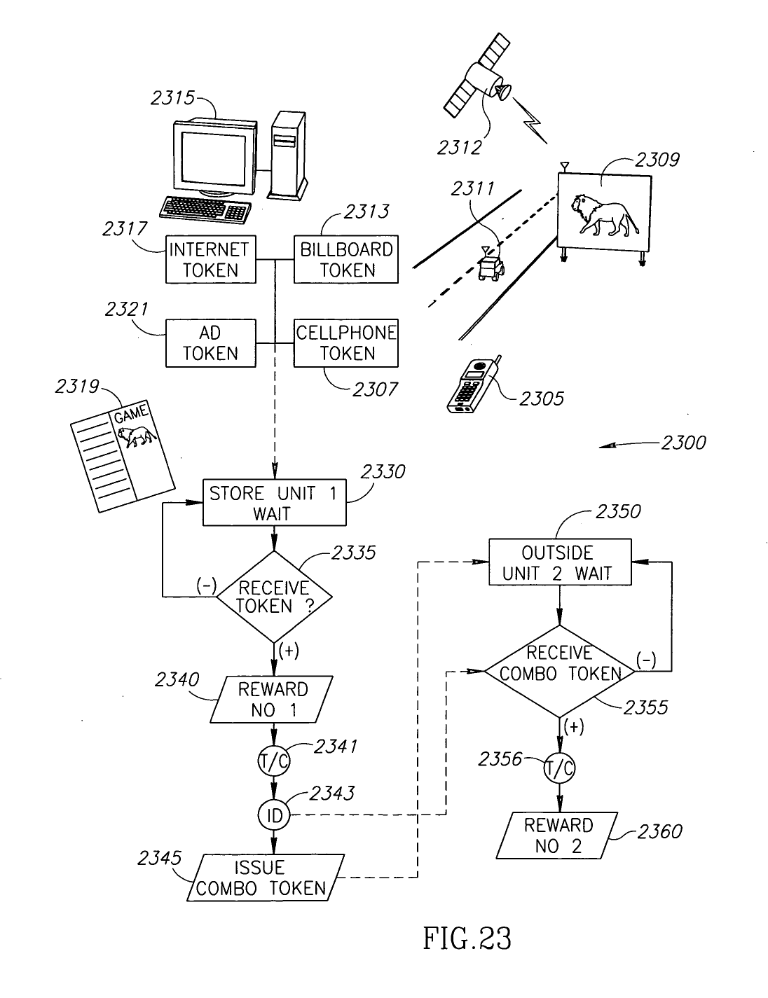

FIG. 23 is a flowchart and pictograph of a multi-modal game sequence 2300 in accordance with an embodiment of the present invention. A user utilizing a computer 2315 may obtain an entertainment sequence token or information key at a block 2317 through a computer network such as the Internet. Alternately or additionally, a user may obtain a token or an information key at a block 2313 from a billboard 2309 as the customer drives by in the customer's vehicle 2311. The user may obtain a token or information key from a print advertisement 2319 at a block 2321. Similarly, a user may obtain a token or information key at a block 2307 by using a cell phone 2305 (as desired, the access to the token or information key limited to a user at or near a specific location identified by the cell phone using a GPS satellite 2312) to call-in to an information number.

The user then proceeds to a first store, by way of example only a stuffed animal store, where a first unit interactive game augmented marketing unit, unit 1, waits at a block 2330. At a decision block 2335, the unit 1 determines whether the user has brought in a token from one of the outside modes of token or information key delivery described above, or other predetermined modes. If no token or key is stated or delivered, the unit 1 continues to wait at the block 2330.

If the user has brought in the token, at a block 2340, the token issues reward no. 1, such as a coupon or some form of entertainment. The user's delivery of the token is tallied at a block 2341, and the customer's identification information is taken at a block 2343 utilizing the unit sensors.

Then, at a block 2345, the unit issues a combination information key such as:

23A: System: “Thank you for playing our ‘Locate the Lion’ game. If you go to the zoo in the next two weeks and go to the lion exhibit and say, ‘Lions are my favorite,’ you'll get a free ice cream cone at the zoo food court.”

The user then takes the information key, “Lions are my favorite” to the zoo, and the customer ID information is also transferred to a game unit at the zoo. The user suitably may also or alternately be given a physical token reflecting this step in the game.

At the zoo, or in other games at a predetermined location ‘outside’ or away from the first facility, an outside unit 2 waits at a block 2350. The user approaches and delivers the information key:

23B: User: “Lions are my favorite.”

At a decision block 2355, the unit checks for the combination key and the identification of the customer. If the user is not identified or if the key (or token, if a token is provided by the sequence) is not correct, the outside unit 2 continues to wait at the block 2350. By way of example, but not limitation, the combination key “Lions are my favorite” is described as a combination information key because the information necessary to walk into the zoo with the combination key requires that the customer have by some means acquired, the first information key, and gone to the store where unit 1 was waiting at the block 2330 and proceeded through that process, only then to obtain the follow-up or combination key. In this game, the customer can get the free ice cream only by having been first identified at the first location, and then proceeding to the zoo to present the combination key at the decision block 2355.

At a block 2356, the customer's delivery of the combination key in connection with their identifying information is tallied and reward no. 2 is issued at a block 2360:

23B: System: “Thank you for visiting the stuffed animal store and the zoo and liking our lions, your coupon for a free ice cream cone is printing.”

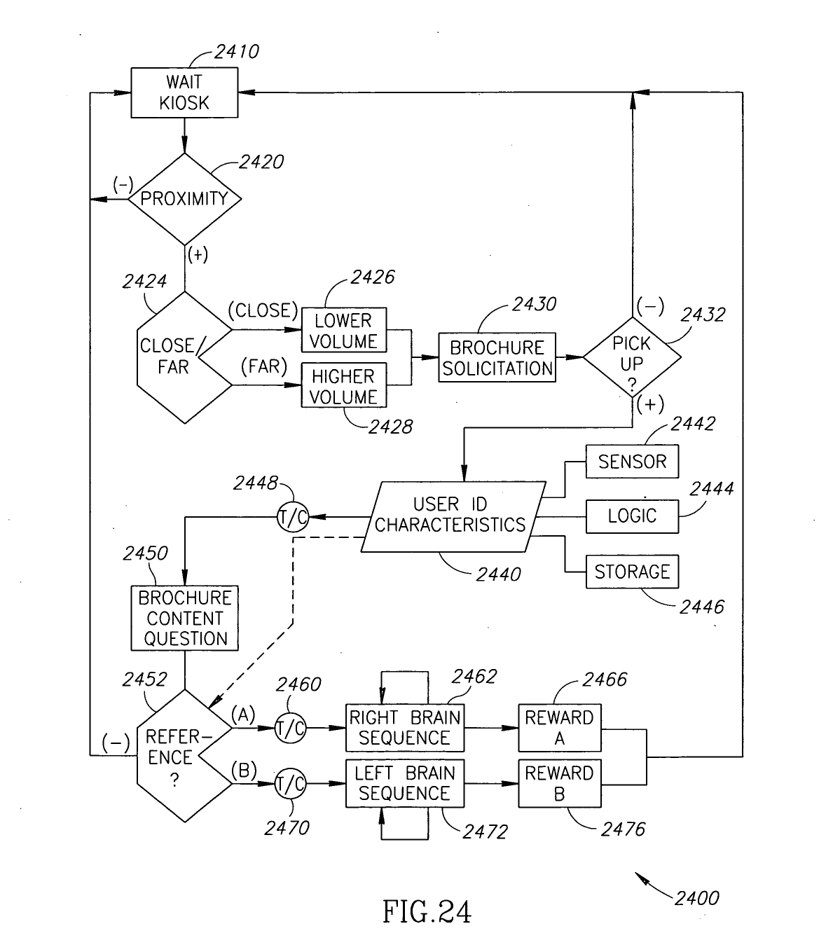

FIG. 24 is a flowchart of a right brain (intuitive, creative)/left brain (analytic, logic) game sequence 2400 that permits verification of a customer's absorption of a refined or second order specific marketing impression or program as may be expressed in a specific advertisement (“refined marketing impression”), in accordance with an embodiment of the present invention. A kiosk with an interactive marketing device waits at a block 2410, sensing for the proximity of a customer at a decision block 2420. If no customer is sensed in proximity, the device returns to waiting at the block 2410. If an approaching customer is sensed, at a decision block 2424, a determination is made as to whether the customer is close, such as within 10 feet of the device, or farther away, such as 20 to 30 feet away, at a decision block 2424. If the customer is close, the device implements a lower volume at a block 2426. If the customer is further away, the device implements a higher volume at a block 2428.

In either case, at block 2430 the device then solicits the customer, such as concerning a marketing brochure, with an audio communication at a block 2430, by way of example, stating:

24A: System: “Glacier Cruise Lines is offering something very special for your considering an Alaska cruise. Please pick up the Glacier Cruise Lines brochure and turn to page 2 for your reward,” or

24A′: System: “Have you ever dreamed of cruising and seeing glaciers? If so, a Glacier Cruise Lines brochure and special offer await you at our kiosk”.

At a block 2432, the device monitors whether a brochure has been picked up by the customer. If no brochure is picked up, the device returns to waiting at the block 2410. If a brochure is picked up, the interactive device acquires user identifying characteristics at a block 2440. The device processes sensor information at a block 2442 generating a set of user identification characteristics, utilizing identifying logic algorithms at a block 2444, and stored information concerning customers or identifying characteristic patterns at a block 2446.

At a block 2448, the customer's identification characteristics are compiled or tallied. By way of example, if a tally is maintained, a count will be kept of the number of customers who picked up the Glacier Cruise Lines brochure. If a compilation or a more compiled data list is being assembled, by way of example, the customer ID characteristics of the customer picking up the brochure, together with a notation that the customer has picked up the brochure, may be stored, or relayed to other units, for further marketing steps.

The interactive device then proceeds with a question concerning content in the brochure at a block 2450. The brochure content question elicits a response from the customer verifying the customer's absorption of a ‘refined marketing impression’, or ‘second order marketing impression,’ i.e., detailed data concerning the cruise lines derived from the brochure. This is in a situation where the customer, by picking up the brochure has already had an initial marketing impression or a first order marketing impression. Two first order impressions here are hearing the “Glacier Cruise Lines” name and picking up the Glacier Cruise Lines brochure, which impressions are confirmed at the block 2432 above. The process 2400 thus permits the tallying and/or compilation of degrees of confirmed absorption of second order or refined advertising impressions. This information is of greater specificity and content than an impression count, and is of substantial value to those using the device, including marketing researchers, and companies marketing their product or services.

In this example, brochure content question/text at the block 2450 may be:

24B: System: “The Glacier Cruise Lines luxury cruiser ‘Glacier Cub’ has special cabin “cozy bear loungers” in all cabins, and “bear view zoom scopes” on the observation deck. The ‘bear view loungers’ are cozy swing away reclining seats that hold you at eye level at your cabin window in soft comfort to either doze or watch bears as you drift by. The ‘bear view zoom scopes' on the observation deck are handheld ‘heads-up’ digital laser displays allowing you to ‘point and shoot’ and zoom in on anything you see. You get an enhanced digital enlargement view plus voice over telling you where you are looking. Which attracts you most—‘a:’ dozing off with an eye level cozy view in your own cabin or ‘b:’ zooming in on a bear on Rainbow point on Kodiak Island?

An alternate content question/text at the block 2450 may be:

24B′: System: “The brochure has information regarding pricing, cabin features and pictures of cruise special sightings; which of these is most important for the brochure?”

At a decision block 2352, the customer's preference is received and analyzed. If there is no intelligible response, or the customer has left, the device returns to waiting at the block 2410.

If the customer responds:

23C: Customer: “A—a cozy bear seat,” for the first example, or

23C′: Customer: “the pictures,” for the second example,

the customer's response is tallied or compiled at a block 2460, reflecting understanding or absorption of the refined marketing impression of this feature of the cruise lines, and also as indicative or suggestive of a right brain response or preference.

Customer identifying characteristics may also be included in tallying or compiling the preference. Customer identification characteristics have been acquired at the block 2440. Characteristics such as voicing intonation or walking patterns may be recorded. The interactive process may contain other questions designed to indicate a leaning towards right brain or left brain customer preferences or tendencies. In general terms, for the purposes of follow-up profile marketing, left brain customers focus on logical thinking, processing, analysis and accuracy. Right brain customers, on the other hand, focus on aesthetics, feeling, understanding context and creativity. The questions presented at the block 2450 seek to differentiate between aesthetic interested customers and analytic interested customers. For example, the aesthetically interested customers will likely express a preference for coziness, while the analytic customers likely express an interest in identifying geographical locations. In the alternative example, the customer is expressing a preference for facts and information (left brain) versus feelings/visualization and “mind photos” (right brain).

With the customer having expressed a more right brain response, the device can then enter into a right brain entertainment, questions, marketing, or game play sequences at a block 2462. Block 2462 can include a number of cycles of questions, sensory experiences, or preference selections as described with respect to other the embodiments of this invention as described above, with the experiences, questions, and preferences directed towards musical or aesthetic experiences, or feeling based information. At a block 2466, following the right brain sequence at the Block 2462, a reward A is tendered to the customer tailored again to the right brain orientation as expressed by the customer. After tendering the reward, the system returns wait at the block 2410.

In this example, a different customer's left brain response at the block 2352 may be:

24D: Customer: “B—I like the bear location scope,”

for the first example question, or

24D′: Customer: “pricing,” for the second example question.

The customer's response is tallied or compiled at a block 2470, as indicative of absorbing the refined marketing impression of this feature of the cruise lines, and also as indicative or suggestive of a left brain response or preference.

The customer's response reflecting a more left brain, logical thinking, analysis, or accuracy interest, may by way of example, be augmented by analysis or merging of the customer identifying characteristics input at the block 2440, as described above. The customer's “left brain” oriented responses are tallied and/or compiled at a block 2470.

The system then enters into a left brain directed entertainment, question, game, or marketing sequence at a block 2472. This suitably may include several cycles of entertainment, questions, preferences, in this branch directed toward the logical or analysis based orientation of the customer.

Upon completion of the left brain sequence at the block 2472, a reward B is tendered to the customer at a block 2476, the reward B reflecting the customer's expressed or derived left brain interest. Upon the tendering of the reward at the block 2476, the system returns to wait at a block 2410 for subsequent customers.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A system for interactive information presentation comprising:
a first interactive unit, including a first processor, the first processor adapted to run an entertainment sequence, the entertainment sequence including a plurality of steps taken by a user; a first sensor, in data communication with the first processor, the first sensor adapted to sense information concerning the user related to the entertainment sequence; a first output device in data communication with the first processor adapted to transmit predetermined media to the user related to the entertainment sequence; and a first input device adapted to receive information from the user related to the game sequence; and
a second interactive unit adapted to run the entertainment sequence, including a second sensor adapted to sense information concerning the user related to the entertainment sequence; second output device adapted to transmit predetermined media to the user related to the entertainment sequence; and a second input device adapted to receive information from the user related to the game sequence.

2. The system of claim 1, wherein the entertainment sequence includes a game.

3. The system of claim 2, wherein the game includes a marketing message.

4. The system of claim 1, wherein the entertainment sequence includes a marketing message.

5. The system of claim 1, wherein the first sensor includes an ultrasonic sensor.

6. The system of claim 1, wherein the first sensor includes an infrared detector.

7. The system of claim 1, wherein the first sensor includes a pressure sensor.

8. The system of claim 1, wherein the at least one sensor includes an RFID tag sensor.

9. The system of claim 1, wherein the at least one sensor includes a magnetic stripe card reader.

10. The system of claim 1, wherein the first output device includes a projector adapted to project an image related to the entertainment sequence.

11. The system of claim 1, wherein the first output device includes a visual display adapted to display information related to the entertainment sequence.

12. The system of claim 1, wherein the first output device includes a switch adapted to control a powered device, the switch triggerable by the processor.

13. The system of claim 1, wherein the first input device includes a speech recognition system.

14. The system of claim 1, wherein the predetermined media includes an information key for inputting into one of the first interactive unit and the second interactive unit.

15. The system of claim 1, wherein the information from the user includes information from one of the first interactive unit and the second interactive unit.

16. The system of claim 15, wherein the information concerning the user includes a compilation of a position of the user in the entertainment sequence.

17. The system of claim 1, wherein the first interactive unit includes a storage device in data communication with the first processor adapted to store information concerning the user.

18. The system of claim 16, wherein the data storage device is adapted to store a voice message from the user.

19. The system of claim 16, wherein the data storage device is adapted to store a compilation of user steps taken related to the entertainment sequence.

20. The system of claim 1, wherein the second interactive unit includes a second processor adapted to run the entertainment sequence, the second processor being in data communication with the second output device, the second sensor, and the second input device.

21. A method for interactive communication, comprising:
detecting a user in proximity to a first interactive device;
soliciting a play move from the user with the first device, the play move including taking at least one step from a game sequence;
receiving a response by the user to a second interactive device with the play move; and
tallying the play move of the user.

22. The method of claim 21 wherein the play move includes a disclosure of information by the user verifying receipt by the user of a predetermined message.

23. The method of claim 22 wherein the predetermined message includes a marketing logo.

24. The method of claim 22 wherein the predetermined message includes a marketing slogan.

25. The method of claim 22 wherein the predetermined message includes a marketing jingle.

26. The method of claim 22 wherein the predetermined message includes product data.

27. The method of claim 21, further comprising:
receiving a response by the user to the first interactive device.

28. The method of claim 21, further comprising:
directing the user to move to the second interactive device.

29. The method of claim 21, further comprising:
identifying the user.

30. The method of claim 29, further comprising:
identifying the user by the second interactive device with a user characteristic acquired by the first interactive device.

31. The method of claim 29 wherein identifying the user includes acquiring a data set including a plurality of identifying characteristics.

32. The method of claim 29 wherein identifying the user includes acquiring a name of the user.

33. The method of claim 29, further comprising:
communicating a result of identifying the user between the first interactive device and the second interactive device.

34. The method of claim 29, wherein identifying the user includes sensing a pressure applied by the user to a pressure sensor.

35. The method of claim 21, further comprising:
soliciting a game move from the user with the second interactive device, the second game move including at least one step from the game sequence.

36. The method of claim 21, further comprising:
offering a reward to the user.

37. The method of claim 21, further comprising:
compiling at least one play move of the user and a user identification characteristic into a user linked play pattern record; and
storing the user linked play pattern record.

38. The method of claim 37, further comprising:
transmitting the play pattern record to a remote computer.

39. The method of claim 21, further comprising:
informing the user that a game sequence is available for game playing.

40. The method of claim 21, further comprising:
rewarding the user for the play move of the user.

41. The method of claim 21 wherein the responding by the user includes movement to a predetermined location.

42. The method of claim 21 wherein the responding by the user includes picking up a predetermined product.

43. The method of claim 21 wherein the responding by the user includes answering a question.

44. The method of claim 21 wherein the responding by the user includes completing a phrase.

45. The method of claim 21 wherein the responding by the user includes asking a question.

46. The method of claim 21 wherein the responding by the user includes the user making a statement.

47. The method of claim 21, further comprising:
delivering a token to a user; and
recognizing the token delivered to the user.

48. The method of claim 46, wherein the token includes a physical object.

49. The method of claim 43, wherein the delivering the token is performed by the first interactive device.

50. The method of claim 43, wherein the receiving the token is performed by the second interactive device.

51. The method of claim 21, further comprising:
delivering an information key to a user; and
recognizing the information key delivered to the user.

52. The method of claim 21 wherein the soliciting a play move and the responding by the user occur at a single store.

53. The method of claim 21 wherein the soliciting a play move and the responding by the user occur at a first premises and a second premises, respectively, the first premises and the second premises being remote from each other.

54. The method of claim 23 wherein one of the first premises and the second premises is a location of a personal computer.

55. The method of claim 23 wherein one of the first premises and the second premises is a location of a kiosk.

56. The method of claim 23 wherein one of the first premises and the second premises is a location of a portable electronic device.

57. A method for interactive communication, comprising:
detecting a user in proximity to a first interactive device;
soliciting a play move from the user with the first device, the play move including taking at least one step from a game sequence;
receiving a response by the user to the first interactive device;
identifying a user characteristic of the user by the first interactive device
transmitting data reflecting the user characteristic from the first interactive device to a second interactive device;
identifying the user by the second interactive device;
receiving a response by the user to the second interactive device with the play move; and
tendering a reward to the user.

58. The method of claim 57, further comprising:
directing the user, as part of the game sequence, to the second interactive device at another physical location.

59. The method of claim 57, further comprising:
tallying the play move of the user.

60. The method of claim 57, further comprising:
compiling a set of data concerning the user from the first interactive device and the second interactive device.

61. A system for interactive entertainment comprising:
a first entertainment unit, including a first processor, the first processor adapted to run an entertainment sequence, the entertainment sequence including a plurality of steps that may be taken by a user; at least one first sensor, in data communication with the first processor, the at least one first sensor adapted to sense information concerning the user related to the entertainment sequence; at least one first input device adapted to receive information from the user related to the game sequence; and a first output device in data communication with the first processor adapted to transmit a first predetermined media to the user related to the entertainment sequence;
a second entertainment unit, including a second processor, the second processor adapted to run the entertainment sequence; at least one second sensor, in data communication with the second processor, the sensor adapted to sense information concerning the user related to the entertainment sequence; and at least one second input device adapted to receive information from the user related to the game sequence; a second output device in data communication with the second processor adapted to transmit a second predetermined media to the user related to the entertainment sequence; and
a parent unit, including a third processor, the parent unit having a communication link to the first and second entertainment units.

62. The system of claim 61 wherein the entertainment sequence includes a game.

63. The system of claim 61 wherein the parent unit further includes a data storage device arranged to store information concerning the user.

64. The system of claim 63 wherein the data storage device is adapted to store a compilation of user steps taken related to the entertainment sequence.

65. The system of claim 61 wherein the parent unit further includes means for communicating user information to at least one of a product manufacturer and a product distributor.

66. The system of claim 61 wherein the at least one first sensor includes adaption to sense a proximity of the user to the first entertainment unit.

67. The system of claim 61, wherein the information from the user includes information from one of the first interactive unit and the second interactive unit.

68. The system of claim 61, wherein the predetermined media includes an information key for inputting into one of the first interactive unit and the second interactive unit.

69. The system of claim 61, wherein the parent unit includes a storage device adapted to store information concerning the user.

70. The system of claim 69, wherein the information concerning the user includes a record of a position of the user in the entertainment sequence.

71. The system of claim 61, wherein the at least one first sensor includes an ultrasonic sensor.

72. The system of claim 61, wherein the at least one first sensor includes an infrared detector.

73. The system of claim 61, wherein the at least one first sensor includes a pressure sensor.

74. The system of claim 61, wherein the at least one sensor includes an RFID tag sensor.

75. The system of claim 61, wherein the at least one first sensor includes a magnetic flux reader.

76. The system of claim 61, wherein the at least one first input device includes a speech recognition system.

77. The system of claim 61, further comprising:
a data storage device in data communication with the first processor.

78. The system of claim 77 wherein the data storage device is adapted to store a voice message from the user.

79. A method for interactive information presentation, comprising:
detecting a user in proximity to a first interactive device;
soliciting a play move from the user with the first interactive device, the play move including taking at least one step from a game sequence;
receiving a response by the user with the play move; and
storing information concerning the user and information concerning the play move of the user upon a central processing unit.

80. The method of claim 79, further comprising:
acquiring an identifying characteristic of the user.

81. The method of claim 79, further comprising:
identifying the user utilizing the identifying characteristic.

82. The method of claim 79 wherein identifying the user includes acquiring a name of the user.

83. The method of claim 79 wherein the identifying characteristic includes a pressure applied by the user to a pressure sensor.

84. The method of claim 79, wherein the receiving the response by the user is by a second interactive device.

85. The method of claim 84 wherein the second interactive device is remote from first interactive device.

86. The method of claim 79 wherein the central processing unit is remote from first interactive device.

87. The method of claim 79, further comprising:
informing the user that a game sequence is available for a game play.

88. The method of claim 79, further comprising:
rewarding the user for the play move of the user.

89. The method of claim 79 wherein storing information concerning the user includes storing a plurality of identifying characteristics of the user.

90. The method of claim 79 wherein storing information concerning the user includes storing a name of the user.

91. The method of claim 79 wherein soliciting a play move from the user includes adjusting a volume of the soliciting based upon a distance between the first interactive device and the user.

92. The method of claim 79, further comprising:
delivering a token to a user;
recognizing the token delivered to the user.

93. The method of claim 91, wherein the token includes a physical object.

94. The method of claim 91, wherein the delivering the token is performed by the first interactive device.

95. The method of claim 91, wherein the receiving the token is performed by a second interactive device.

96. The method of claim 79, further comprising:
delivering an information key to a user;
recognizing the information key delivered to the user.

97. The method of claim 79 wherein receiving the response by the user with the play move includes the user disclosing information verifying receipt by the user of a predetermined message.

98. The method of claim 79, further comprising:
directing the user to a second interactive device.

99. The method of claim 79 further comprising:
identifying the user.

100. The method of claim 99 wherein identifying the user includes identifying by the second interactive device utilizing an identifying characteristic of the user.

101. The method of claim 79, further comprising:
soliciting a second game move from the user with a second interactive device, the second game move including at least one step from the game sequence.

102. The method of claim 79, further comprising:
tendering a reward to the user.

103. The method of claim 79, further comprising:
transmitting the information concerning the user and information concerning the play move of the user to a remote processor.

104. The method of claim 79, further comprising:
informing the user that a game sequence is available for game playing.

105. The method of claim 79 wherein the receiving the response by the user with the play move includes recognizing the user picking up a predetermined product.

106. The method of claim 79 wherein the receiving the response by the user with the play move includes receiving an answer to a question.

107. The method of claim 79 wherein the soliciting a play move and the receiving the response by the user occur at a single location.
